(19) United States
(12) Patent Application Publication
(10) Pub. No.: US 2020/0060374 A1
(43) Pub. Date: Feb. 27, 2020

(54) Removable Communications Module Pocket

(71) Applicant: VICIS, Inc., Seattle, WA (US)

(72) Inventors: Travis E. GLOVER, Seattle, WA (US); Kurt V. FISCHER, Seattle, WA (US); Kayla Y. FUKUDA, Seattle, WA (US); Anton P. ALFERNESS, Seattle, WA (US); David L. MARVER, Seattle, WA (US); Jason NEUBAUER, Seattle, WA (US); Cord SANTIAGO, Seattle, WA (US); Ryan SMITH, Seattle, WA (US); Adam FRANK, Seattle, WA (US)

(21) Appl. No.: 16/568,700

(22) Filed: Sep. 12, 2019

Related U.S. Application Data
(63) Continuation of application No. PCT/US18/23031, filed on Mar. 16, 2018.
(60) Provisional application No. 62/473,246, filed on Mar. 17, 2017.
(60) Provisional application No. 62/550,660, filed on Aug. 27, 2017.

(51) Int. Cl. A42B 3/12; A42B 3/30; H04B 1/3827

(52) U.S. Cl. CPC A42B 3/127; H04B 2001/3866; H04B 1/385; A42B 3/30

(57) ABSTRACT

The invention herein relates to an improved helmet design that allows enhanced modularity and quick installation of various types of computing equipment, electronics, electronic communications modules (ECMs), stock impact mitigation pads and/or custom impact mitigation pads within a commercially available helmet. A commercially available helmet can be retrofitted with a pocket or chamber that sized and configured to receive a protective enclosure. The protective enclosure may house at least one of an electronic communications modules (ECMs), stock impact mitigation pads or custom impact mitigation pads. The protective enclosure can be quickly and easily secured within the pocket or chamber disposed within the helmet. Such improved helmet design may be customized to the specific ECM, and its protective enclosure may also be small, lightweight, durable and/or low-profile, but yet not sacrifice comfort and impact performance of the helmet.

### CROSS-REFERENCE TO RELATED APPLICATIONS

This application is a continuation of International Application No. PCT/US2018/023031, entitled “Removable Communication Module Pocket,” filed Mar. 16, 2018, which claims the benefit of U.S. Provisional Patent Application No. 62/473,246 entitled “Removable Communication Module Pocket,” filed Mar. 17, 2017, and U.S. Provisional Patent Application Ser. No. 62/550,660 entitled “Helmet Information System and Display,” filed Aug. 27, 2017, the disclosures of which each are hereby incorporated by reference in its entireties.

### TECHNICAL FIELD

This invention relates to a system, apparatus, and/or method of retrofitting commercially available helmets to accommodate wired or wireless electronic systems. More specifically, the invention relates to of retrofitting commercially available helmets to accommodate wired or wireless electronic systems to enhance comfort, impact performance of the helmet, and battery longevity.

### BACKGROUND OF THE INVENTION

The incorporation of electronic communication modules (ECM), e.g., a one-way radio, into athletic helmets and/or other protective gear has been a recent popular development. Incorporating an ECM into an athletic helmet can offer many advantages to an athlete/player, such that they can allow the athlete to perform multiple functions at the same time, including the ability to intermittently and/or continuously view information presented visually by a display; potentially provide safety or help prevent injuries; increases field of view to observe the surrounding environment and the field of play; and/or allows “real-time” communication with coaches that sit on the sidelines.

However, the current methods of coupling or securing ECM into athletic helmets are not optimal because they may affect the safety of the player. Such non-optimal coupling or securement methods are often inconsistent or haphazard because (1) layout of each commercially available helmet varies making the securement complicated to figure out; (2) the experience and skill of the game-day equipment coordinator varies; (3) the tools and equipment (i.e., Velcro, tape, etc.) available for each team varies; (4) the size and fit of the helmet on the player varies; and/or any combination thereof. This leads to the helmets potentially becoming unsafe to wear due to direct contact of ECM to the head of player, the impact performance of the helmet may be affected, helmets become heavy and bulky, the helmets can have unequal distribution of weight, the system component can make the helmet awkward to wear and potentially provide unacceptable stress on the player's neck or head, the ECM may become more prone to damage, the system requires teams to keep extra ECM back-ups with their respective batteries in case of malfunctions or injury to players, and/or the system components require game-day coordinators to continuously confirm function resulting in significant time and effort, and potential waste of tools and equipment.

### BRIEF SUMMARY OF THE INVENTION

Consequently, there is a need for an improved helmet design that allows quick installation or coupling of various types of ECM components within a commercially available helmet to minimize many of these potential problems to the player. More specifically, such improved helmet design may be customized to the specific ECM, and its protective enclosure may also be small, lightweight, durable and/or low-profile, but yet not sacrifice comfort and impact performance of the helmet.

In one exemplary embodiment, the improved invention may comprise a method to assemble an ECM helmet system. The method can comprise the steps of: obtaining or selecting a commercially available (CA) helmet, the CA helmet having at least one outer layer and at least one impact mitigation layer; identifying a preferred regional location within the CA helmet where a protective enclosure may be positioned; removing at least a portion of the at least one impact mitigation layer to create a pocket or chamber sized and configured to receive a protective enclosure; and securing the protective enclosure within the pocket or chamber.

In another exemplary embodiment, the improved invention may comprise an alternative method to assemble an ECM helmet system. The method can comprise the steps of: obtaining or selecting a commercially available (CA) helmet, the CA helmet having at least one outer layer, and at least one comfort liner assembly; identifying a preferred regional location within the CA helmet where a protective enclosure may be positioned; removing at least a portion of the at least one comfort liner assembly to create a space or void sized and configured to receive a protective enclosure; and securing the protective enclosure within the space or void.

In another exemplary embodiment, the improved invention may comprise an alternative method to assemble an ECM helmet system. The method can comprise the steps of: obtaining or selecting a commercially available (CA) helmet, the CA helmet having at least one outer layer, and at least one comfort liner assembly; identifying a preferred regional location within the CA helmet where a protective enclosure may be positioned; removing at least a portion of the at least one comfort liner assembly to create a space or void; modifying the least a portion of the at least one comfort liner assembly with a cavity to create a protective enclosure; and securing the protective enclosure within the space or void.

In another exemplary embodiment, the ECM helmet system may comprise a CA helmet with a protective enclosure. The ECM helmet system may comprise a commercially available (CA) helmet, the CA helmet comprising at least one outer layer, and an impact mitigation layer; a pocket or chamber being disposed within the impact mitigation layer, the pocket or chamber sized and configured to receive a protective enclosure; the protective enclosure having a cavity or a space; the cavity or space being sized and configured to receive at least one ECM or at least one impact mitigation pad; and the protective enclosure being removably connected within the pocket or chamber.

In another exemplary embodiment, the protective enclosure may be provided without a lid. The protective enclosure may comprise a base, the base having a first surface and a second surface, the first surface having a cavity disposed therein, the cavity being sized and configured to receive at least one ECM or at least one impact mitigation pad; the base being coupled to an impact mitigation structure.

In another exemplary embodiment, the protective enclosure may be provided with a lid. The protective enclosure may comprise a base and a lid; the base having a first surface and a second surface, the first surface having a cavity disposed therein, the cavity being sized and configured to receive at least a first portion of least one ECM or at least a first portion of at least one impact mitigation pad; the lid having a first surface and a second surface the first surface having a cavity disposed therein, the cavity being sized and configured to receive at least a second portion of least one ECM or at least a second portion of at least one impact mitigation pad; the lid being coupled to the base; the base being coupled to an impact mitigation structure.

In another exemplary embodiment, the protective enclosure may comprise a cavity accessed from a variety surfaces. The protective enclosure may comprise a base, the base having a first surface and a second surface, the first surface having a cavity disposed therein, the cavity being sized and configured to receive at least one ECM or at least one impact mitigation pad; the first surface being a surface from at least one inner surface, outer surface, side surface, top surface, bottom surface, bisecting midplane, bisecting offset plane, and/or any combination thereof; the base being coupled to an impact mitigation structure.

In one exemplary embodiment, an ECM may comprise a plurality of electronic systems. Such electronic modules may include one or more of a heads-up displays (HUD), one or more head-mounted displays (HMD), computer processing units (CPUs), optical communication systems, radio communication systems (e.g., one-way communication and/or two-way communication systems), full duplex communication systems, half-duplex communication systems, tactile communication systems, digital communication systems, power supplies (non-rechargeable or rechargeable), speakers, mobile phones, tablets, microphones, projector units, and/or any combination thereof.

In another exemplary embodiment, the CA helmet may comprise helmets used in one or more athletic activities such as football, baseball, bowling, boxing, cricket, cycling, motorcycling, golf, hockey, lacrosse, soccer, rowing, rugby, running, skating, skateboarding, skiing, snowboarding, surfing, swimming, table tennis, tennis, or volleyball, any training sessions related athletic activities thereto, and/or any combination thereof.

### BRIEF DESCRIPTION OF THE SEVERAL VIEWS OF THE DRAWINGS

The foregoing and other objects, aspects, features, and advantages of embodiments will become more apparent and may be better understood by referring to the following description, taken in conjunction with the accompanying drawings, in which:

FIGS. 1A-1B illustrate flowcharts with different embodiments for the method of retrofitting a CA helmet with a protective enclosure;

FIGS. 2A-2B illustrate flowcharts with different embodiments for the method of retrofitting a CA helmet with a protective enclosure using “position-specific” factors;

FIG. 3 illustrates a flow chart with one embodiment for the method of retrofitting a CA helmet comfort liner with a protective enclosure;

FIGS. 4A-4B depict one embodiment of a CA helmet with its helmet components;

FIGS. 5A-5D depict one embodiment of CA helmet with an impact mitigation layer using filaments;

FIGS. 6A-6B depict one embodiment of CA helmet with an impact mitigation layer using TPU cones;

FIGS. 7A-7B depict one embodiment of CA helmet with an impact mitigation layer using inflatable bladders;

FIGS. 8A-8B depict one embodiment of CA helmet with an impact mitigation layer using impact foam;

FIGS. 9A-9B depict one embodiment of CA helmet with an impact mitigation layer using shock bonnets;

FIG. 10 depict one embodiment of a CA helmet with an impact mitigation layer using flexible patterns;

FIGS. 11A-11B depict various embodiments of desired regional locations on a CA helmet;

FIGS. 12A-12B depict one embodiment of a CA helmet with the lower-back region selected for retrofitting;

FIGS. 13A-13C depict one embodiment of a CA helmet with the jaw flap region selected for retrofitting;

FIGS. 14A-14E depicts one embodiment of a CA helmet retrofitting method through removal of a portion of a comfort liner assembly to removably couple a protective enclosure;

FIGS. 15A-15F depicts one embodiment of a CA helmet retrofitting method through removal of a portion of a helmet outer layer to removably couple a protective enclosure;

FIGS. 16A-16D depicts one embodiment of a CA helmet retrofitting method through removal of a portion of a comfort liner assembly to replace with a protective enclosure that includes a modified portion of the comfort liner assembly;

FIG. 17 illustrates various embodiments of different orientations of a cavity access within a protective enclosure;

FIGS. 18A-18E depict one embodiment of a CA helmet retrofitted pocket to removably couple a protective enclosure within the impact mitigation layer lower-back region;

FIGS. 19A-19B depicts one embodiment of a protective enclosure with an inside/outside access cavity;

FIG. 20 depicts one embodiment of a protective enclosure with a side access cavity;

FIGS. 21A-21B depicts one embodiment of a CA helmet being retrofitted in a jaw flap region;

FIGS. 22A-22B depicts an alternative embodiment of a protective enclosure with a side access cavity;

FIG. 23 depicts one embodiment of a CA helmet with the lower-back region of the impact mitigation layer for retrofitting;

FIGS. 24A-24B depicts one embodiment of a method of removably coupling a protective enclosure within CA helmet within the lower-back region of the impact mitigation layer;

FIGS. 25A-25B depicts one embodiment of a CA helmet being retrofitted in a jaw flap region;

FIGS. 26A-26C depict one embodiment of a protective enclosure with a bisecting mid-plane access cavity;

FIGS. 27A-27B depicts one embodiment of a CA helmet with a bisecting mid-plane protective enclosure;

FIGS. 28A-28B depicts one embodiment of a protective enclosure with an inside and outside access without a lid and with a lid, respectively;

FIGS. 29A-29B depicts one embodiment of protective enclosure with a bisecting mid-plane and offset-plane, respectively;

FIGS. 30A-30B depicts one embodiment of a protective enclosure with a side access cavity including a lid and with a lid, respectively;

FIGS. 31A-31C depicts various embodiments of laterally supported filaments;

FIGS. 32A-32C depict various embodiments of laterally supported filaments on a base membrane;

FIGS. 33A-33B depict various embodiments of auxetic structures;

FIGS. 34A-34C depict cross-sectional views of various embodiments of protective enclosures;

FIG. 35 depicts an isometric view of one embodiment of a protective enclosure with an inside/outside access cavity and a lid;

FIGS. 36A-36C depict cross-sectional views of various embodiment of a protective enclosure;

FIG. 37A depicts one embodiment of an impact mitigation pad removably coupled within a protective enclosure;

FIG. 37B depicts a cross-section view of an impact mitigation pad;

FIGS. 38A-38C depicts an alternate embodiment of a protective enclosure with an impact mitigation pad that may be removably coupled to the jaw-flap region of a CA helmet;

FIGS. 39A-39C depicts one embodiment of a method of retrofitting a CA helmet using a protective enclosure and a removably coupled impact mitigation pad;

FIGS. 40A-40B depict one embodiment of a Heads-Up Display (HUD) ECM positioning within a helmet;

FIGS. 41A-41C depict alternate embodiments of HUDS in different positioning within a helmet;

FIGS. 42A-42C depict various views of alternate embodiments of a protective enclosure; and

FIGS. 43A-43C depict various views of another alternate embodiments of a protective enclosure.

### DETAILED DESCRIPTION OF THE INVENTION

The improved invention relates to an improved ECM Helmet System that provides a significant advantage to the current methods of incorporating electronic communication modules (ECM) within a helmet. The improved ECM Helmet System retrofits or modifies a commercially-available (CA) helmet by removing at least a portion of the CA helmet's outer layer and/or impact mitigation layer to create a pocket or chamber, where a protective enclosure may be removably connected or removably disposed within the pocket or chamber. The protective enclosure may incorporate a cavity that can house either a plurality of electronic communication modules (ECM) or other mitigation pads. The protective enclosure may desirably incorporate impact mitigation structures and at least one foam layer.

The advantages of such an improved ECM Helmet are (1) improving the safety of the player by removing the direct contact of ECM to the head of player, (2) improving the impact performance of the helmet because the protective enclosure may desirably include impact mitigation layers, (3) making the helmets lighter or at least the same weight due to the removal of structures and combination of materials used for the protective enclosure and/or securement (i.e., athletic or “duct” tape”), (4) reduce or eliminate the unequal distribution of weight by strategically placing the pocket and protective enclosure, (5) improves comfort by reducing or eliminating any awkwardness due to unacceptable placement of the ECM, (6) reduces or eliminates the probability of damaging the ECM, (7) reduces or eliminates a need for extra ECM back-ups with their respective batteries in case of malfunctions or injury to players; (8) reduces or eliminates the frequency, time and effort of game-day coordinators to continuously confirm function because of improved protection provided in the protective enclosure, (9) reduces or eliminates potential waste of tools and equipment used to previously affix ECM's to helmets, and/or any combination thereof.

Methods of Retrofitting a CA Helmet into ECM Helmet

As previously disclosed herein, the improved ECM Helmet System can be employed to retrofit or modify a commercially-available (CA) helmet by removing at least a portion of the CA helmet's outer layer, impact mitigation and/or comfort liner to create a pocket or chamber, where a protective enclosure may be removably connected or removably disposed within the pocket or chamber. The protective enclosure may incorporate a cavity that can house at least one electronic communication modules (ECM) or at least one impact mitigation pad. The protective enclosure may desirably incorporate impact mitigation structures and at least one foam layer. The impact mitigation structure may desirably match the CA helmet impact mitigation layer. Conversely, a different impact mitigation structure may be used.

The term “retrofitting” or “modification” of an existing, commercially available helmet (CA helmet) into an electronic communications module helmet (ECM helmet) may require modifications to at least one of the CA helmet outer layer, the CA helmet Impact mitigation layer, and/or both the CA helmet outer layer and the CA helmet Impact mitigation layer. Such modifications may be “minor” or “major.” “Minor CA helmet modifications” is defined as using methods or mechanisms that add or remove at least a portion of the CA helmet outer layer and/or at least a portion the CA helmet impact mitigation layer that do not significantly affect the durability and/or the performance of the CA helmet to a significant degree. “Major CA helmet modifications” is defined as using methods or mechanisms that add or remove at least a portion of the CA helmet outer layer and/or at least a portion the CA helmet impact mitigation structure that significantly affects the durability and/or the performance of the CA helmet to a significant degree.

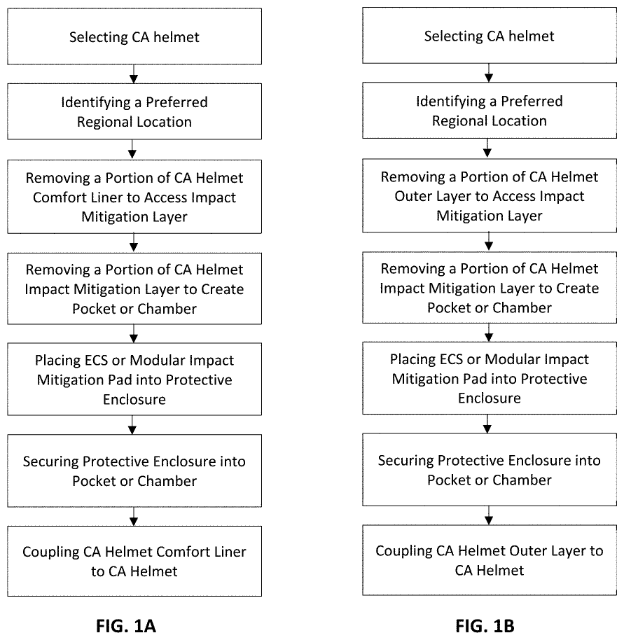

In one embodiment, the method to retrofit an existing CA helmet into an ECM may include the removal of the CA helmet comfort liner to position a protective enclosure within the CA helmet impact mitigation layer as shown in FIG. 1A. The retrofit method comprises the steps: selecting the desired CA helmet; identifying a preferred regional location within the CA helmet (i.e., front, back-upper, back-lower, right-upper side, right-lower side, left-upper side, left-lower side, ridge or top, jaw flap, ear flap, facemask-upper, facemask-central, facemask-side edge and/or any combination thereof) where a protective enclosure may be positioned; removing at least a portion of the CA helmet comfort liner from the CA helmet to access the impact mitigation layer; removing at least a portion of the CA helmet impact mitigation layer to create a pocket or chamber sized and configured to receive a protective enclosure; placing a desired ECM or modular impact mitigation pad into the protective enclosure; securing the protective enclosure within the pocket or chamber; and coupling the CA helmet comfort liner to the CA helmet.

In another embodiment, the method to retrofit an existing CA helmet into an ECM may include the removal of the CA helmet outer layer to position a protective enclosure within the CA helmet impact mitigation layer as shown in FIG. 1B. The retrofit method comprises the steps: selecting the desired CA helmet; identifying a preferred regional location within the CA helmet (i.e., front, back-upper, back-lower, right-upper side, right-lower side, left-upper side, left-lower side, ridge or top, jaw flap, ear flap, facemask-central, facemask-side edge and/or any combination thereof) where a protective enclosure may be positioned; removing at least a portion of the CA helmet outer layer to access the CA helmet impact mitigation layer; removing at least a portion of the CA helmet impact mitigation layer to create a pocket or chamber sized and configured to receive a protective enclosure; placing a desired ECM or modular impact mitigation pad into the protective enclosure; securing the protective enclosure within the pocket or chamber; and coupling the CA helmet comfort liner to the CA helmet.

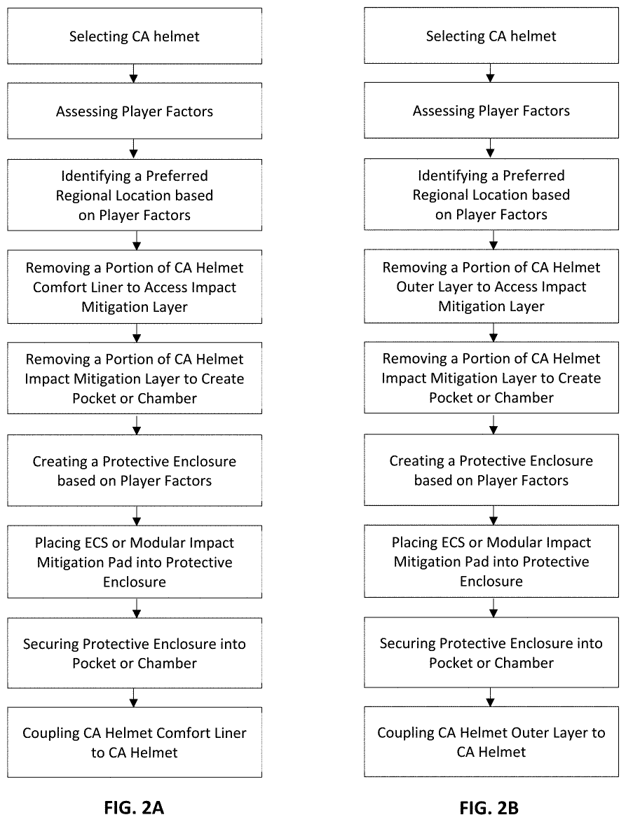

In another embodiment, the method to retrofit an existing CA helmet into an ECM may include the removal of the CA helmet comfort liner for “position-specific” placement within the CA helmet impact mitigation layer as shown in FIG. 2A. The retrofit method comprises the steps: selecting the desired CA helmet; assessing one or more player factors, including the player athletic activity, the player position, the player position, player impact source, player activity type, player play type, the severity of impacts, frequency of impact, and/or any combination thereof; identifying a preferred regional location within the CA helmet (i.e., front, back-upper, back-lower, right-upper side, right-lower side, left-upper side, left-lower side, ridge or top, jaw flap, ear flap, facemask-upper, facemask-central, facemask-side edge and/or any combination thereof) according to the player factor assessment and where a protective enclosure may be positioned; removing at least a portion of the CA helmet comfort liner from the CA helmet to access the CA helmet impact mitigation layer; removing at least a portion of the CA helmet impact mitigation layer to create a pocket or chamber sized and configured to receive a protective enclosure; creating a protective enclosure according to the player factor assessment to enhance impact performance, comfort and safety; placing a desired ECM and/or modular impact mitigation pad into the protective enclosure; securing the protective enclosure within the pocket or chamber; and coupling the CA helmet comfort liner to the CA helmet.

In another embodiment, the method to retrofit an existing CA helmet into an ECM may include the removal of the CA helmet outer layer for “position-specific” placement of a protective enclosure within the CA helmet impact mitigation layer as shown in FIG. 2B. The retrofit method comprises the steps: selecting the desired CA helmet; assessing one or more player factors, including the player athletic activity, the player position, player impact source, player activity type, player play type, the severity of impacts, frequency of impact, and/or any combination thereof; identifying a preferred regional location within the CA helmet (i.e., front, back-upper, back-lower, right-upper side, right-lower side, left-upper side, left-lower, side ridge or top, jaw flap, ear flap, facemask-upper facemask-central, facemask-side edge and/or any combination thereof) according to the player factor assessment and where a protective enclosure may be positioned; removing at least a portion of the CA helmet outer layer from the CA helmet to access the CA helmet impact mitigation layer; removing at least a portion of the CA helmet impact mitigation layer to create a pocket or chamber sized and configured to receive a protective enclosure; creating a protective enclosure according to the player factor assessment to enhance impact performance, comfort and safety; placing a desired ECM and/or modular impact mitigation pad into the protective enclosure; securing the protective enclosure within the pocket or chamber; and coupling the CA helmet outer layer to the CA helmet.

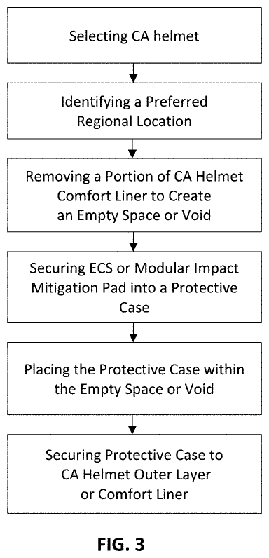

In another embodiment, the method to retrofit an existing CA helmet into an ECM may include the removal of a least a portion of a CA helmet comfort liner to position a protective enclosure within the CA helmet outer layer or the CA helmet comfort liner as shown in FIG. 3. The retrofit method comprises the steps: selecting the desired CA helmet; identifying a preferred regional location within the CA helmet (i.e., front, back-upper, back-lower, right-upper side, right-lower side, left-upper side, left-lower side ridge or top, jaw flap, ear flap, facemask-upper, facemask-central, facemask-side edge and/or any combination thereof) where a protective enclosure may be positioned; removing at least a portion of the CA helmet comfort liner to create an empty space or void; positioning the protective enclosure within the empty space or void; securing the protective enclosure onto at least a portion of the CA helmet outer layer or at least a portion of the CA helmet comfort liner.

Coupling or securing as described herein may include the same mechanisms or methods used to reattach the CA comfort liner to the CA helmet as originally designed or a different mechanism may be used. All coupling mechanisms that may be used may be known in the art, including press-fit, friction-fit, snaps, Velcro, magnets, adhesives, molding, sintering, welding, cam locks, screws and bolts, dovetail, interlocking protrusions (e.g. LEGOs) and/or any combination thereof. Each of these coupling mechanisms may utilize existing features of a CA helmet or may require minor modifications with penetration through at least one of the CA helmet outer layer, CA helmet inner layer, the CA impact absorbing layer, and/or any combination thereof.

Selecting CA Helmets for ECM Helmet Systems

It's understood that virtually any CA helmet from any manufacturer may be selected for retrofitting for improvement and manufacture of the ECM Helmet System. The CA helmet may comprise various helmets used in one or more athletic activities such as football, baseball, bowling, boxing, cricket, cycling, motorcycling, golf, hockey, lacrosse, soccer, rowing, rugby, running, skating, skateboarding, skiing, snowboarding, surfing, swimming, table tennis, tennis, or volleyball, any training sessions related athletic activities thereto, and/or any combination thereof.

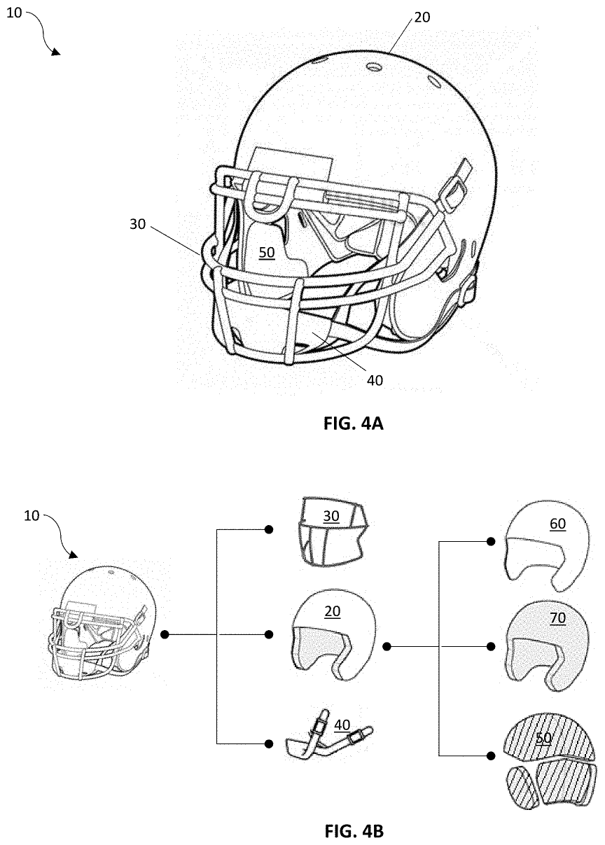

Each of these various CA helmets may utilize similar basic standard features of a helmet design, but can significantly differ on the type of impact mitigation layer technologies. FIG. 4A depicts a front perspective view of one embodiment of a complete CA helmet design 10. Similar standard features on complete CA helmets may include one or more of a helmet structure assembly 20, a facemask 30, chinstrap 40, and/or a comfort liner 50. The comfort liner 50 may have individual pads or be a pad assembly that are regionally located within the helmet to protect the player and provide comfort. The comfort liner 50 may include Individual pads or pad assemblies that are regionally located one or more of front, back-upper, back-lower, right-upper side, right-lower side, left-upper side, left-lower side, ridge or top, jaw flap, ear flap, facemask-upper, facemask-central, facemask-side edge and/or any combination thereof.

FIG. 4B depicts a layered diagram of a complete CA helmet design, separating the main standard components, and the helmet structure assembly. The helmet structure assembly 20 can be further broken down into its specific components, such as the CA helmet comfort liner 50, the CA helmet outer layer 60, CA helmet Impact mitigation layer 70. Differences between the CA helmets designs may focus on materials of the CA helmet outer layer 60 and/or incorporating different impact mitigation layer 70 technologies.

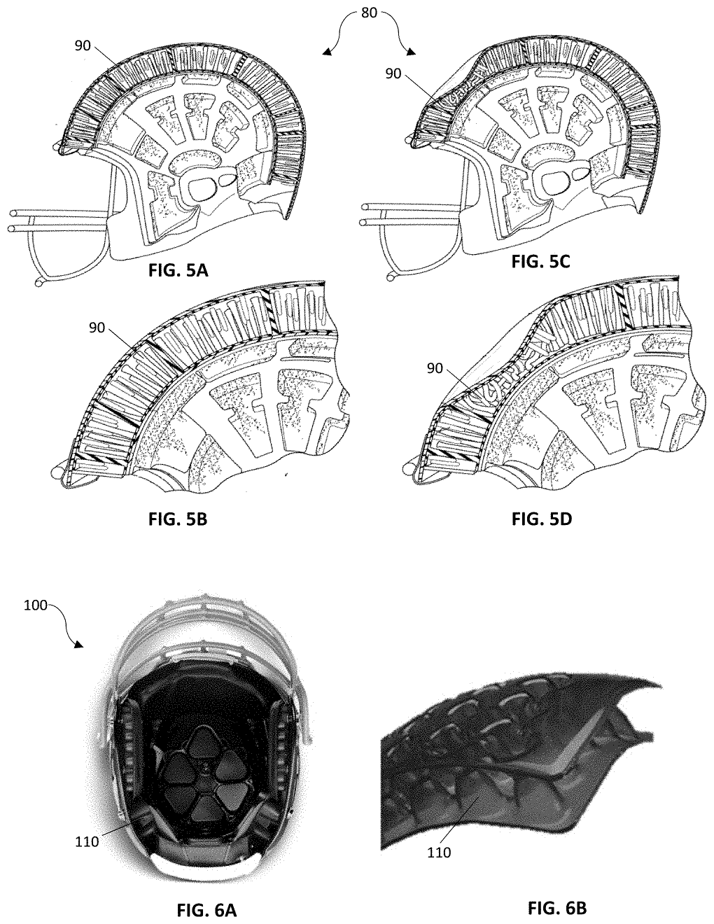

In one example, the impact mitigation layers within the CA helmets can vary significantly because of the different technologies used. FIGS. 5A-5D depict cross-sectional views of one embodiment of a CA helmet impact mitigation layer using buckling columns or filaments 90. In a VICIS specific design, VICIS Zero One 80, the helmet incorporates at least a portion of filaments 90, which may be thin, longitudinally extending members or be shaped and configured to deform non-linearly in response to an impact force (helmet designs commercially available from VICIS, Inc. of Seattle, Wash., USA). The non-linear deformation behavior is expected to provide improved protection against high-impact forces, and/or oblique forces. Such buckling columns or filaments 90 is an advanced and innovative technology to improve safety, comfort and performance.

In another example, FIGS. 6A-6B depict a cross-sectional view of an alternative embodiment of a CA helmet impact mitigation layer using thermoplastic urethane (TPU) cones. TPU bridges the gap between rubbers and plastics and can provide extensive number of physical property combinations that make it adaptable for helmet use. In Schutt's specific design, Schutt Vengeance Pro 100, the helmet uses an impact mitigation layer comprising a pattern of frustoconical shapes or TPU cones 110 that are coupled to the outer layer to help absorb impact (helmets are commercially available from SCHUTT SPORTS MANUFACTURING CO. of Litchfield, Ill., USA).

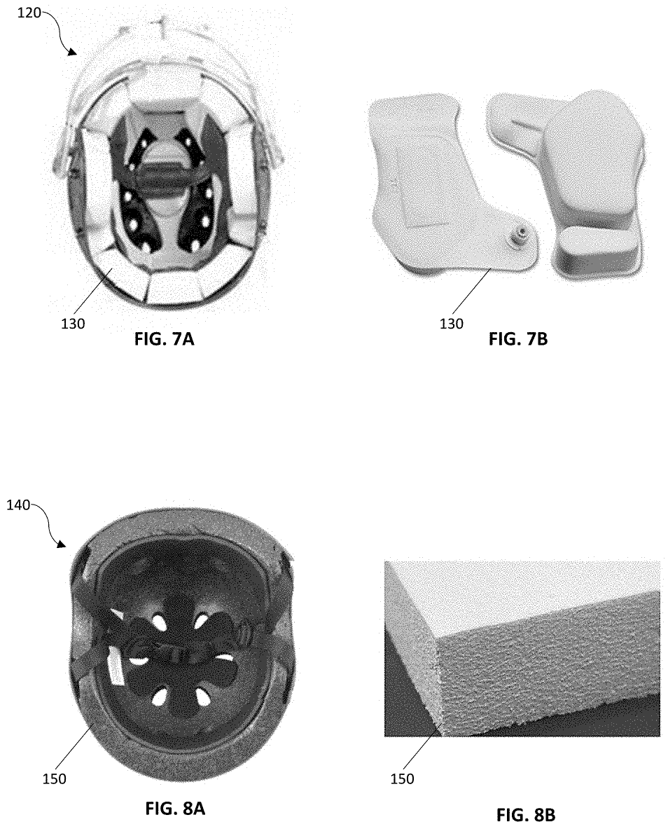

In another example, FIGS. 7A-7B depict a cross-sectional view of an alternate embodiment of a CA helmet impact mitigation layer using inflatable air bladders. In Riddell's specific design, Riddell Speedflex 120, the helmet incorporates adjustable or inflatable bladder pads 130 with an inflation port located at the back of the helmet (helmet designs commercially available from RIDDELL, Inc. of Elyria, Ohio, USA). Such inflatable bladder pads 130 provide impact absorption and some level of comfort for the player.

In another example, FIGS. 8A-8B depict a cross-sectional view of an alternate embodiment of a CA helmet impact mitigation layer using at least one foam layer. In the Triple Eight Distribution specific design, Little Tricky Youth Bicycle Helmet 140, the helmet incorporates a foam layer 150 for energy mitigation (helmet designs commercially available from TRIPLE EIGHT, Inc. Port Washington, N.Y., US). Such foam layers 150 may be constructed of polypropylene, polystyrene, polyethylene, and/or any common energy mitigation foams that are known in the art.

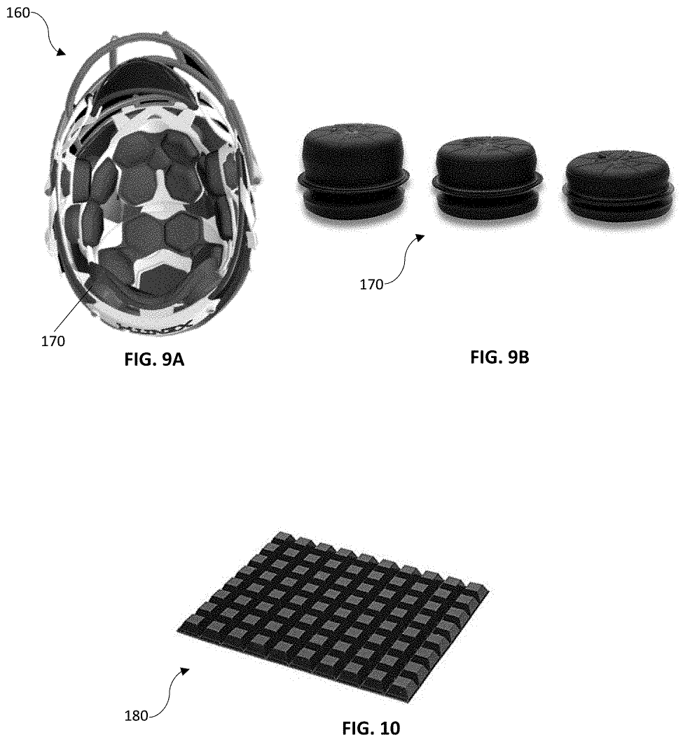

In another example, FIGS. 9A-9B depict a cross-sectional view of an alternate embodiment of a CA helmet impact mitigation layer using shock bonnets. In the Xenith specific design, Xenith X1, the helmet incorporates shock bonnets which are coupled to the outer layer (helmet design commercially available from XENITH. LLC of Detroit, Mich., USA). The shock bonnets are plastic shock absorbers, shaped like small hockey pucks, each of them with a tine hole on top allowing for the disposition of air after impact.

It should be understood that these specific CA helmets are merely exemplary embodiments, and the retrofitting or modification could be utilized with virtually any helmet design from any manufacturer (which all helmet designs of different configurations are representative of a “CA helmet”). Of course, such retrofitting or modification of the CA helmet outer layer, Impact mitigation layer and/or the comfort liner may have a varying level of difficulty that may produce ECM helmets with varying results, but ECM helmets will continue to maintain safety and performance certification as required by the respective athletic governing body.

Identification of Regional Location with or without Assessment of Player Factors

In one embodiment, choosing or Identifying the proper regional location to retrofit a pocket or chamber Into the Impact mitigation layer of a CA helmet may be performed without assessing player factors. Other general factors for the desired regional location may include random selection, ease of placement, regional location where impact performance will not be affected, or reducing/eliminating structural modifications to CA helmet may be significant general factors in deciding which regional location that a pocket or chamber may be performed. FIGS. 11A-11B depict one embodiment of a CA football helmet 190 which may be segmented into different regional locations. The regional locations may include front 210, back-upper 270, back-lower 260, right-upper side 280, right-lower side 250, left-upper side (not shown), left-lower side (not shown), ridge or top 200, jaw flap (not shown), ear flap (not shown) facemask-upper 220, facemask-central 230, facemask-side edge 240 and/or any combination thereof.

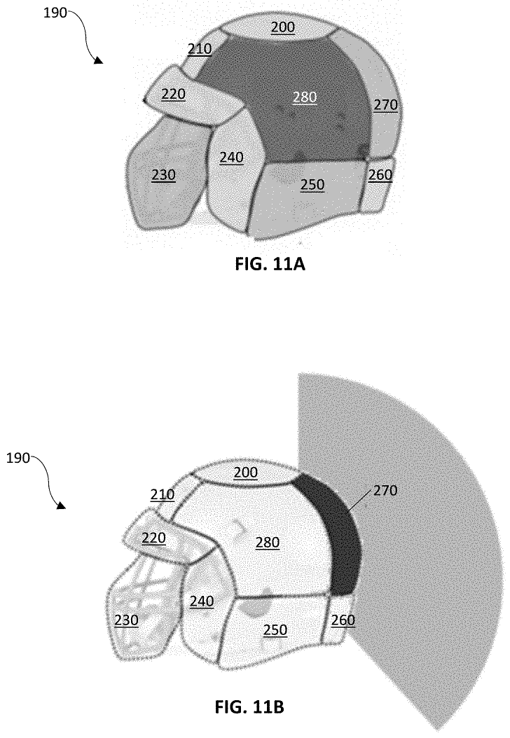

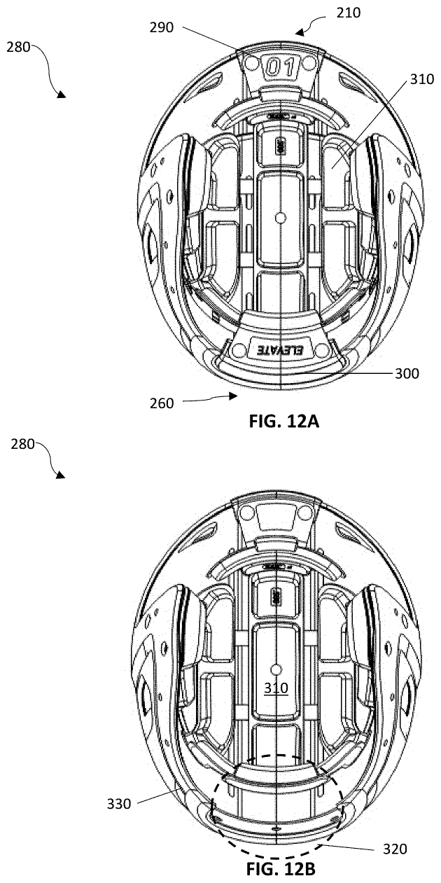

For example, it may be desired to select the front 210 or back-lower 260 regional location because of its ease of access and/or the reduction/elimination of the need for any potential structural modifications to the CA helmet 280. FIG. 12A depicts a bottom view of one embodiment of the back-lower 260 or front 210 regional locations of a CA helmet that has front bumpers 290 and back bumpers 300. The back-lower 260 or the front 210 may include the back bumper 300 and the front bumper 290, respectively. The back-lower 260 may be selected because at least a portion of the CA helmet comfort liner 310 and the back bumper 300 may be removed leaving an opened area or region 320 that is positioned between the CA helmet outer layer 330, and the CA helmet comfort liner 310 as shown in FIG. 12B. This opened region 320 provides access to the impact mitigation layer (not shown). At least a portion of the impact mitigation layer (not shown) may be removed to create a pocket or chamber sized and configured to receive a protective enclosure. Removal may be performed with any method known in the art.

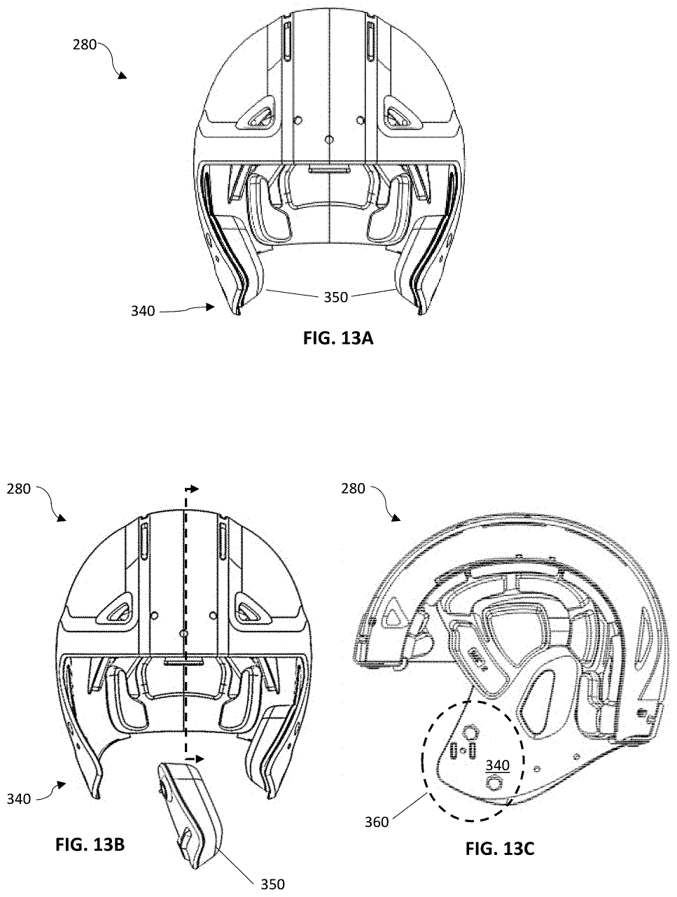

In another example, it may be desired to select the jaw flap regional location 340 because of Its ease of access and the reduction/elimination of any potential structural modifications to the CA helmet 280 as shown In FIGS. 13A-13C. The jaw flap regional location 340 may Include the jaw pad assembly 350 on right side, left side, and/or right and left side. The jaw pad assembly 350 may be removed from the CA helmet jaw flap regional location 340, leaving an empty space or void 360 configured to receive a protective enclosure.

In another embodiment, choosing or Identifying the proper regional location to retrofit a pocket or chamber into the Impact mitigation layer of a CA helmet may be performed with assessing player factors. Such assessment of the player factors may allow the manufacturer of the ECM helmet to predetermine the best regional location for a protective enclosure to be secured and/or enhance the impact protection that may be incorporated into the protective enclosure. Conversely, choosing or identifying the proper regional location to retrofit an empty space or void into CA helmet comfort liner of a CA helmet may be performed with assessing player factors. Such assessment of the player factors may allow the manufacturer of the ECM helmet to predetermine the best regional location for a protective enclosure to be secured. The decision to secure in the selected desired location may enhance the impact protection by incorporating impact mitigation structures into the protective enclosure or it may be to a desired regional location where impact performance may not be affected (the addition of such impact mitigation structures may be optional).

At least one of the various player factors or a combination of two or more player factors revealed in the 2017 NFL Video Review Study may be considered, the disclosure of which is incorporated by reference herein in its entirety. The 2017 NFL Video Review Study analyzed reported concussions sustained by football players in the NFL pre-season, regular season, and post-season games during the 2015 and 2016 season. The video review summarized that there were various player factors that were evident that may provide opportunities to enhance the safety and performance of a helmet. Such player factors may include, but not limited to, source of impact, angle or vector of impact, player activity type, play type, player position, location of impact, angle of impact, severity of impact, frequency of impacts, and/or any combination thereof.

For example, the NFL study video review revealed that the side of the helmet is the regional location most commonly associated with concussion causing impacts. However, other regional locations, such as the front 210, back-upper 270, back-lower 260, right-upper side 280, right-lower side 250, left-upper side (not shown), left-lower side (not shown), ridge or top 200, jaw flap, ear flap, facemask-upper 220, facemask-central 230, facemask-side edge 240 and/or any combination thereof, may be considered. Understanding that the sides or the back of the helmet are more frequently associated with concussion-causing impacts allows the manufacturer to customized placement of a retrofitted chamber or pocket and/or an empty space or void, where a protective enclosure may be positioned.

The player factor assessment allows the specific identification of the regional location of where not to consider retrofitting a chamber or pocket. In other words, the user may identify a regional location that Is proximate to the area that receives the most impacts or identify a location with the least amount of impacts for the specific player (i.e., where impact performance of the helmet would unlikely be affected by placement of a chamber or pocket). Conversely, the assessment may reveal that it would be beneficial to place a protective enclosure incorporating supplemental impact mitigation structures to enhance the safety and performance to protect the player in a regional location that receives more impacts.

Removal of a Portion of the CA Helmet

As disclosed herein, to retrofit a CA helmet into an ECM helmet, removal of least a portion of the CA helmet structure assembly should or could occur. As shown in FIG. 4B, the helmet structure assembly may comprise a CA helmet outer layer, CA helmet impact mitigation layer, and a CA comfort liner assembly.

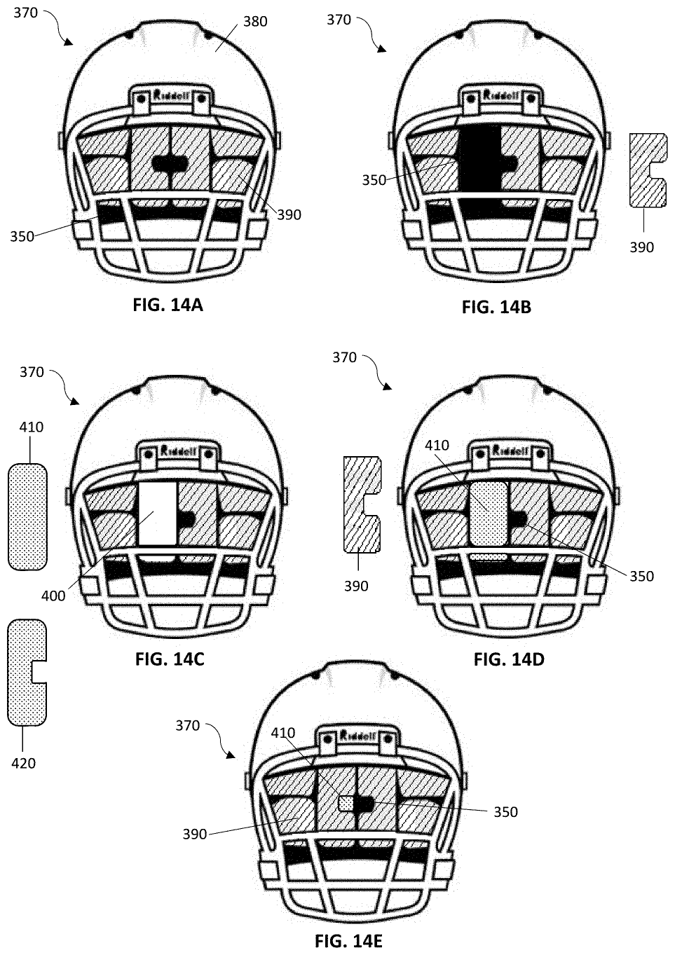

In one embodiment, the removal of at least a portion of a CA helmet comfort liner 50 may be accomplished to access the CA impact mitigation layer 70 after the regional location is identified. FIGS. 14A-14E depict various illustrations of the removal of such a portion of a CA helmet comfort liner assembly. For example, FIG. 14A illustrates one embodiment of a complete CA helmet 370, with a CA helmet outer layer 380, a CA impact mitigation layer 350, and a CA helmet comfort liner assembly 390. Removing a portion of the CA helmet comfort liner assembly may be easy or difficult depending the coupling mechanism of the CA helmet manufacturer. Some CA helmet manufacturers have the CA helmet comfort liners assemblies coupled using snap mechanisms, where others may use Velcro (e.g. hook and loop). Usually, the coupling mechanisms couple the CA comfort liner to the CA helmet outer layer to prevent sliding, and strong securement. The CA comfort liner may be removed without affecting the integrity of the existing coupling mechanisms designed into the CA comfort liner assemblies. Should the integrity of the coupling mechanisms from the CA comfort liner assembly to the CA outer layer is maintained, replacement of the coupling mechanisms may not be necessary. Conversely, should the integrity of the coupling mechanism integrity be affected, they can be replaced with the same coupling mechanisms originally designed or replaced with comparable coupling mechanisms known in the art. As a result, the removal results may vary.

Removal of a portion of the CA comfort liner assembly 390 as shown in FIG. 14B will allow the access to impact mitigation layer 350. The portion of the CA comfort liner assembly 390 may be set aside for reattachment. Subsequently, the careful and proper removal of at least a portion of the CA helmet impact mitigation layer 350 should occur to create a chamber or pocket 400 within the CA helmet impact mitigation layer 350. The removal may occur using standard tools known in the art.

The pocket or chamber 400 may be sized and configured to receive a custom 420 or standard 410 sized and shaped protective enclosure as shown in FIG. 14C. For a custom pocket or chamber, the pocket or chamber may be sized and shaped substantially larger, substantially similar, or smaller than the size and shape of the desired custom protective enclosure. For example, if the pocket or chamber 400 is sized and configured or sized and shaped smaller than the size and shape of the protective enclosure, placing the protective enclosure within the pocket chamber may allow a “press-fit” or tight “friction-fit” eliminating the need for further securement or coupling mechanisms. The pocket or chamber 400 may be sized and shaped substantially larger, substantially similar, or smaller than the size and shape of the portion of the CA helmet comfort liner 390 that was removed. In addition, custom size and shape of the pocket or chamber may be customized to the size of the ECM being used. Furthermore, the size and shape of the pocket or chamber 400 may assume a standard size (e.g., small, medium, large, etc.) to accept standard sized protective enclosures (e.g., small, medium, and large).

The standard sized and shaped protective enclosure 410 can be secured within the pocket or chamber 400 and secure the at least a portion of the CA comfort liner 390 over the protective enclosure 410. Coupling or securing as described herein may include the same mechanisms or methods used to reattach the CA comfort liner assembly to the CA helmet as originally designed or a different mechanism may be used. All coupling mechanisms that may be used may be known in the art, including press-fit, friction-fit, snaps, Velcro, magnets, adhesives, molding, sintering, welding, cam locks, screws and bolts, dovetail, interlocking protrusions (e.g. LEGOs) and/or any combination thereof. Each of these coupling mechanisms may utilize existing features of a CA helmet or may require minor modifications with penetration through at least one of the CA helmet outer layer, CA helmet inner layer, the CA impact absorbing layer, and/or any combination thereof.

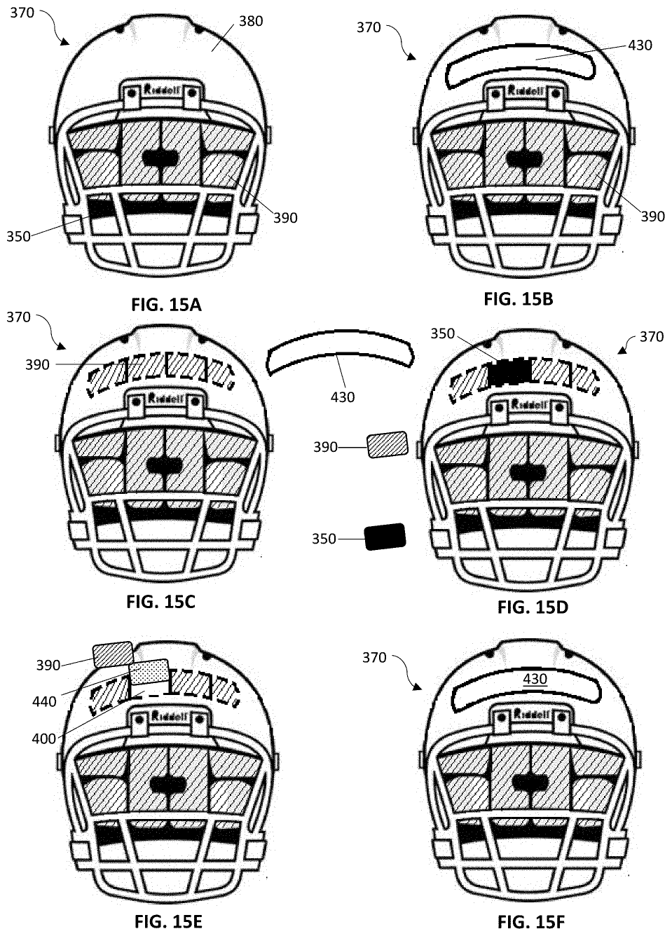

In another embodiment, the removal of at least a portion of a CA helmet outer layer may be desired to allow access to the CA impact mitigation layer after the regional location is identified. FIGS. 15A-15F depict one embodiment of the removal of at least a portion of a CA helmet outer layer. For example, FIG. 15A illustrates one embodiment of a complete CA helmet 370, with a CA helmet outer layer 380, a CA impact mitigation layer 350, and a CA helmet comfort liner 390. Once the desired location is selected, such as shown in FIG. 15B, at least a portion of the CA helmet outer layer 430 may be removed.

Removal of at least a portion of the CA helmet outer layer 430 may be performed as shown in FIG. 15B using careful standard techniques known in the art to remove hard shell plastic structures, as well as any techniques that may help reduce and/or minimize damage to the structural integrity of the helmet. The shape and configuration of the removal of at least a portion of the CA helmet outer layer 430 may be the same and/or substantially similar to the shape and configuration of the protective enclosure that can be inserted. The at least a portion of the CA helmet outer layer 430 that was removed may be set-aside for later reattachment to CA helmet, and/or it may be further processed. Further processing may include polished edges to decrease or eliminate any rough edges, creation of beveling or chamfers, creation of through-holes or threaded holes to help coupling the at least a portion of the CA helmet outer layer to the CA helmet structure assembly.

Furthermore, the removal of at least a portion of the CA helmet outer layer 430 may expose the CA helmet comfort liner 390 as shown in FIG. 15C, if the CA helmet comfort liner 390 was not moved previously. Alternatively, at least a portion of the CA comfort liner 390 may optionally be removed before at least a portion of the CA helmet outer layer 430 removal. Removing a portion of the CA helmet comfort liner 390 may be easy or difficult depending the coupling mechanism of the CA helmet manufacturer. Some CA helmet manufacturers have the CA helmet comfort liners 390 coupled using snap mechanisms, where others may use Velcro (e.g. hook and loop). Usually, the coupling mechanisms couple the CA comfort liner 390 to the CA helmet outer 380 layer to prevent sliding, and strong securement. The CA comfort liner 390 may be removed without affecting the integrity of the existing coupling mechanisms designed into the CA comfort liner 390. Should the integrity of the coupling mechanisms from the CA helmet comfort liner 390 to the CA helmet outer layer 380 be maintained, replacement of the coupling mechanisms may not be necessary. Conversely, should the integrity of the coupling mechanism integrity be affected, they can be replaced with the same coupling mechanisms originally designed or replaced with comparable coupling mechanisms known in the art. As a result, the removal results may vary.

After removal of least a portion of the CA helmet comfort liner 390, the at least a portion of the impact mitigation layer can be exposed 350 as shown in FIG. 15D. Subsequently, the careful and proper removal of at least a portion of the impact mitigation layer 350 may be performed to create a chamber or pocket 400 within the CA helmet impact mitigation layer 350. The removal may occur using standard tools known in the art.

The pocket or chamber 400 may be sized and configured to receive a custom 440 or standard (not shown) sized and shaped protective enclosure, such as shown in FIG. 15E. For a custom pocket or chamber, the pocket or chamber may be sized and shaped substantially larger, substantially similar, or smaller than the size and shape of the desired custom protective enclosure 440. For example, if the pocket or chamber 400 is sized and configured or sized and shaped smaller than the size and shape of the protective enclosure, placing the protective enclosure within the pocket chamber may allow a “press-fit” or tight “friction-fit” eliminating the need for further securement or coupling mechanisms. The pocket or chamber 400 may be sized and shaped substantially larger, substantially similar, or smaller than the size and shape of the portion of the CA helmet comfort liner 390 that was removed. In addition, custom size and shape of the pocket or chamber may be customized to the size of the ECM being used. Furthermore, the size and shape of the pocket or chamber 400 may assume a standard size (e.g., small, medium, large, etc.) to accept standard sized protective enclosures (e.g., small, medium, and large).

FIG. 15E depicts the standard sized and shaped protective enclosure 440 to be secured within the pocket or chamber 400 and secure the at least a portion of the CA comfort liner assembly 390 over the protective enclosure 440. Coupling or securing as described herein may include the same mechanisms or methods used to reattach the CA comfort liner to the CA helmet as originally designed or a different mechanism may be used. All coupling mechanisms that may be used may be known in the art, including press-fit, friction-fit, snaps, Velcro, magnets, adhesives, molding, sintering, welding, cam locks, screws and bolts, dovetail, interlocking protrusions (e.g. LEGOs) and/or any combination thereof. Each of these coupling mechanisms may utilize existing features of a CA helmet or may require minor modifications with penetration through at least one of the CA helmet outer layer, CA helmet inner layer, the CA impact mitigation layer, and/or any combination thereof.

Finally, the at least a portion of the CA helmet outer layer 430 may be secured to one or more of the CA helmet 370, with a CA helmet outer layer 380, a CA impact mitigation layer 350, and a CA helmet comfort liner 390 as shown in FIG. 15F. Coupling or securing as described herein may include the same mechanisms or methods used to reattach the CA comfort liner to the CA helmet as originally designed or a different mechanism may be used. All coupling mechanisms that may be used may be known in the art, including press-fit, friction-fit, snaps, Velcro, magnets, adhesives, molding, sintering, welding, cam locks, screws and bolts, dovetail, interlocking protrusions (e.g. LEGOs) and/or any combination thereof. Each of these coupling mechanisms may utilize existing features of a CA helmet or may require minor modifications with attachment to and/or penetration through at least one of the CA helmet outer layer, CA helmet inner layer, the CA impact mitigation layer, and/or any combination thereof.

FIGS. 16A-16D depict another embodiment allowing removal of at least a portion of a comfort liner from a complete CA helmet 450 and replacing the at least a portion of a comfort liner with a protective enclosure. The complete CA helmet 450 may comprise at least one outer layer 470, an impact mitigation layer (not shown) and a comfort liner assembly 460, such as shown in FIG. 16A. FIG. 16B depicts one embodiment of a comfort liner assembly 460 within a complete CA helmet 450. The comfort liner assembly 460 may include one or more individual pads that are regionally located within the CA helmet for maximum comfort and enhanced impact resistance. Such regional locations may include front 510, back-upper 520, back-lower 530, right-upper side 480, right-lower side (not shown), left-upper side 500, left-lower side (not shown), ridge or top 490, jaw flap 540, ear flap (not shown), facemask-upper (not shown), facemask-central (not shown), facemask-side edge (not shown) and/or any combination thereof. However, comfort liner assemblies disposed within various CA helmet manufacturers may vary. It is understood that this particular embodiment is illustrated to highlight the one or more individual pads that may be regionally located within the helmet, and any portion of the comfort liner assembly 460 may be removed in any desired location.

FIG. 16B depicts at least a portion of the comfort liner assembly 530 being removed after the regional location is identified. Such removal will desirably create a void or empty space 550 within the CA comfort liner assembly 460. The removal of a portion of the CA helmet comfort liner assembly may be easy or difficult depending on the coupling mechanism of the CA helmet manufacturer. Some CA helmet manufacturers can have the CA helmet comfort liner assemblies coupled using snap mechanisms, where others may use Velcro (e.g. hook and loop). Usually, the coupling mechanisms couple the CA comfort liner assembly to the CA helmet outer layer to prevent sliding, and strong securement. The at least a portion of the CA comfort liner assembly may be removed without affecting the integrity of the existing coupling mechanisms designed into the CA comfort liner assembly. Should the integrity of the coupling mechanisms from the CA comfort liner to the CA outer layer be maintained, replacement of the coupling mechanisms may not be necessary. Conversely, should the integrity of the coupling mechanism integrity be affected, they can be replaced with the same coupling mechanisms originally designed or replaced with comparable coupling mechanisms known in the art. As a result, the removal results may vary.

The empty void or space 550 within the CA comfort liner assembly 460 may be replaced or substituted with a protective enclosure 560 as shown in FIG. 16D. The shape and configuration of the removal of at least a portion of the CA helmet comfort liner assembly 530 may be same or substantially similar to the shape and configuration of the protective enclosure 560 that can be inserted. The protective enclosure 560 may be removably coupled to the CA comfort liner assembly 460, the CA helmet outer layer 470, the impact mitigation layer (not shown), and/or any combination thereof. Coupling or securing as described herein may include the same mechanisms or methods used to reattach the CA comfort liner assembly to the CA helmet as originally designed or a different mechanism may be used. All coupling mechanisms that may be used may be known in the art, including press-fit, friction-fit, snaps, Velcro, magnets, adhesives, molding, sintering, welding, cam locks, screws and bolts, dovetail, interlocking protrusions (e.g. LEGOs) and/or any combination thereof. Each of these coupling mechanisms may utilize existing features of a CA helmet or may require minor modifications with penetration through at least one of the CA helmet outer layer, CA helmet inner layer, the CA impact mitigation layer, and/or any combination thereof.

Protective Enclosure Cavity Access and Structure

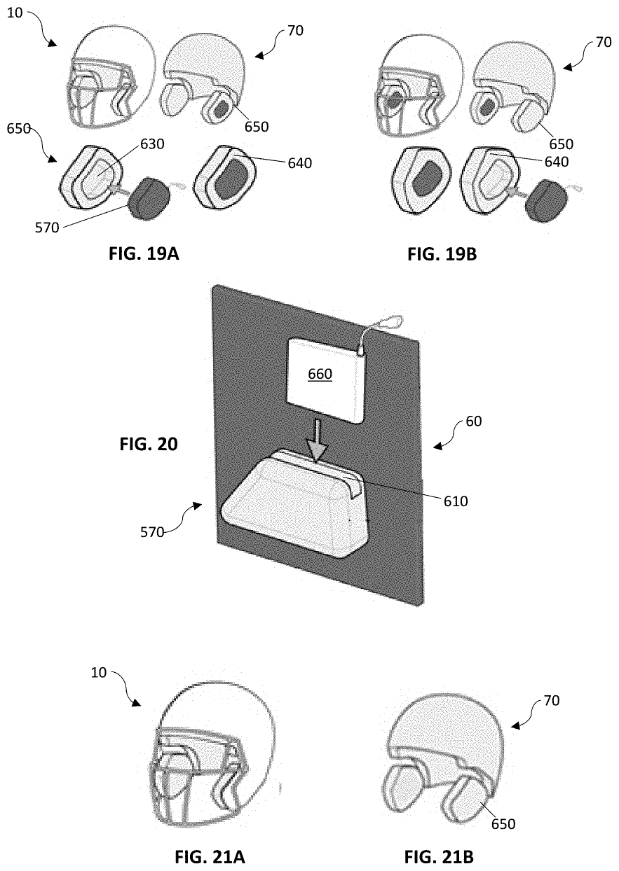

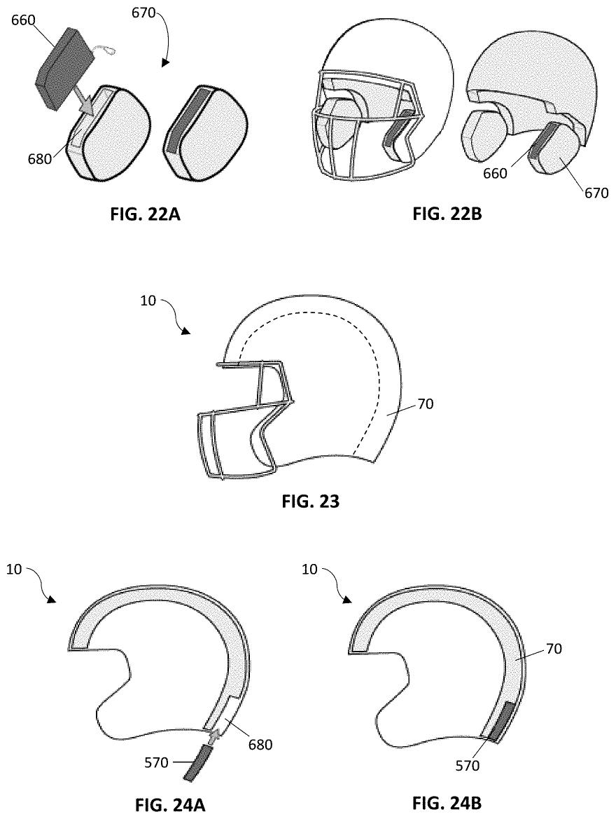

In one embodiment, the protective enclosure 570 may be a separate independent enclosure assembly that can replace a portion of the comfort liner assembly (see FIGS. 13A-13C and/or 16A-16D) or be positioned within the pocket or chamber created after removal of a portion of an impact mitigation layer (see FIGS. 23 and 24A-24B). Alternatively, the protective enclosure may be created from a portion of the original comfort liner assembly, where a pocket or chamber is created when a portion of the original comfort liner assembly is removed (see FIGS. 19A-19B).

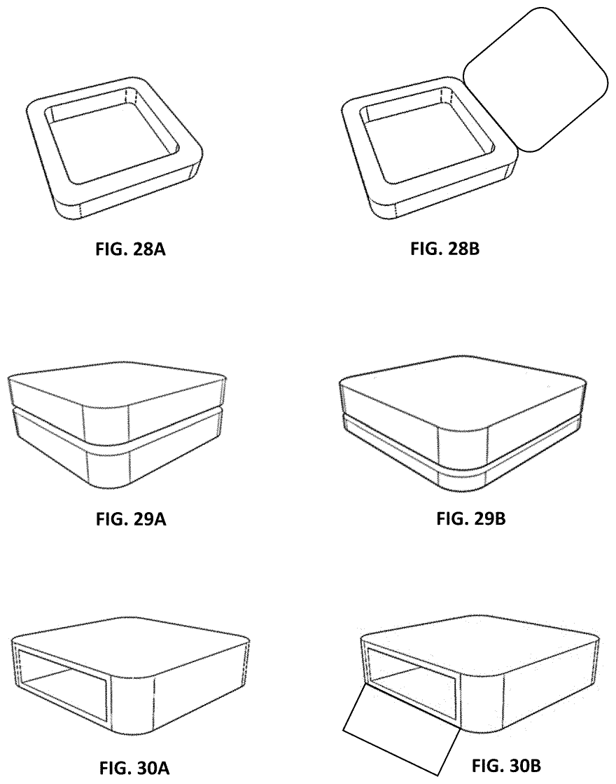

FIGS. 28A to 30B, and FIGS. 42A-42C illustrate various views of the different embodiments of the protective enclosure. In one embodiment, the protective enclosure may comprise at least one base, at least one lid, and a hinge as shown in FIGS. 28B, 29A-29B and 30B. The base may have a first surface and a second surface, the first surface having at least one cavity or recess disposed within, the at least one cavity extending from the first surface towards the second surface. The at least one cavity may extend at least a portion towards the second surface. The at least one cavity may be at ¼ planar towards to the second surface, ½ planar (or mid-planar) towards the second surface, and ¾ planar towards the second surface. Optionally, the protective enclosure may have at least one lid, the at least one lid may be coupled or removably coupled to the base (see also FIGS. 28B, 29A-29B, and 30B). Furthermore, the coupling may comprise a pivotal connection, the pivotal connection having a hinge. The hinge may be a flexible hinge or a mechanical (friction-based hinge). The base may comprise of various materials, including metal, polymers and/or foam. In one particular embodiment, the foam may comprise ethylene-vinyl acetate (EVA) foam, polyurethane (PU) foam, polyethylene (PE) foam, memory foam, Evlon, Supreem foam, Poron XRD foam, closed cell foam, open cell foam, any impact protection foam, and/or any combination thereof. Furthermore, the base. In addition, the cavity may be thermoformed, molded, machined, and/or any formed using any methods known in the art.

In another embodiment, the protective enclosure 1110 may be an integrally connected one-piece design that comprises at least one base 1140, at least one lid 1130, and a hinge 1150 as shown in FIGS. 42A-42C. The base 1140 may have a first surface and a second surface, the first surface having at least one cavity or recess 1120 disposed within, the at least one cavity 1120 extending from the first surface towards the second surface. The at least one cavity 1120 may extend at least a portion towards the second surface. The at least one cavity 1120 may be at ¼ planar towards to the second surface, ½ planar (or mid-planar) towards the second surface, and ¾ planar towards the second surface. The at least one lid may be coupled to the base, the coupling may comprise a pivotal connection, the pivotal connection having a hinge. The hinge may be a flexible hinge or a mechanical (friction-based hinge). The base may comprise of various materials, including metal, polymers and/or foam. In one particular embodiment, the foam may comprise ethylene-vinyl acetate (EVA) foam, polyurethane (PU) foam, polyethylene (PE) foam, memory foam, Evlon, Supreem foam, Poron XRD foam, closed cell foam, open cell foam, any impact protection foam, and/or any combination thereof. In addition, the integrally connected one-piece protective enclosure may be thermoformed, molded, machined, and/or any formed using any methods known in the art.

In one embodiment, the protective enclosure may comprise at least one base, at least one lid, and at least a portion of an impact mitigation structure. The base may have a first surface and a second surface, the first surface having at least one cavity or recess disposed within, the at least one cavity extending from the first surface towards the second surface. The at least one cavity may extend at least a portion towards the second surface. The at least one cavity may be at ¼ planar towards to the second surface, ½ planar (or mid-planar) towards the second surface, and ¾ planar towards the second surface. The at least one lid may be coupled or removably coupled to the base (see also FIGS. 28B, 29A-29B, and 30B). The at least a portion of the impact mitigation structure may be coupled to the base, the lid, and/or the base and the lid. The base may comprise of various materials, including metal, polymers and/or foam. In one particular embodiment, the foam may comprise ethylene-vinyl acetate (EVA) foam, polyurethane (PU) foam, polyethylene (PE) foam, memory foam, Evlon, Supreem foam, Poron XRD foam, closed cell foam, open cell foam, any impact protection foam, and/or any combination thereof. Furthermore, the base. In addition, the cavity may be thermoformed, molded, machined, and/or any formed using any methods known in the art.

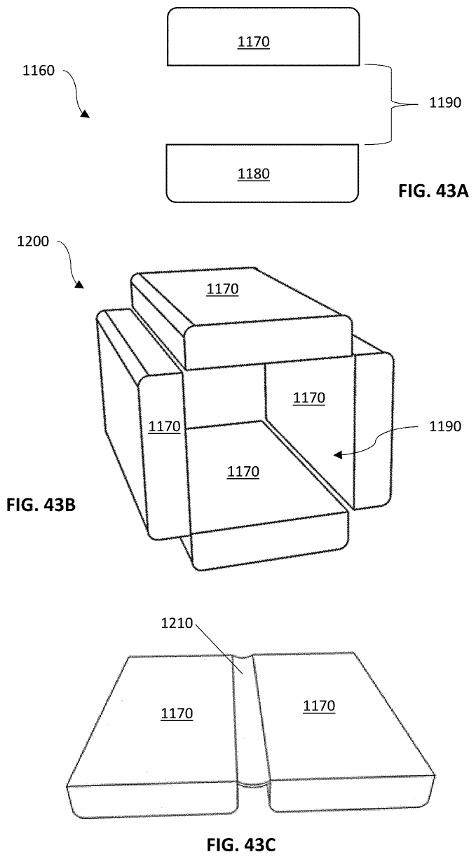

In another embodiment, the protective enclosure 1160 may comprise at least one base 1170 and at least one lid 1180 or a second base (not shown) forming a space 1190 therebetween as shown in FIG. 43A. The space 1190 may be sized and configured to receive at least one ECM or an impact mitigation pad. The base 1170 may further comprise a recess (not shown), the base having a first surface and a second surface, the first surface having at least one cavity or recess disposed within, the at least one cavity extending from the first surface towards the second surface. The at least one cavity may extend at least a portion towards the second surface. Alternatively, the protective enclosure 1200 may further comprise two or more bases 1170, the two or more bases 1170 may be arranged to form a space 1190 therebetween as shown in FIG. 43B. The two or more bases may be positioned proximate to each adjacent base forming peripheral walls and the space therebetween. The bases 1170 positioned proximate to each adjacent base may be further comprise a coupling 1210 as shown in FIG. 43C, the coupling 1210 may comprise a friction or a pivotal connection, the pivotal connection having a hinge. The hinge may be a flexible hinge or a mechanical (friction-based hinge). The bases may comprise of various materials, including metal, polymers and/or foam. In one particular embodiment, the foam may comprise ethylene-vinyl acetate (EVA) foam, polyurethane (PU) foam, polyethylene (PE) foam, memory foam, Evlon, Supreem foam, Poron XRD foam, closed cell foam, open cell foam, any impact protection foam, and/or any combination thereof. If desired, the at least lid (not shown) may be positioned over the space 1190 therebetween.

In another embodiment, the at least one cavity may be sized and configured to receive electronics communications modules (ECMs) or impact mitigation pads. The approximate dimensions of said cavity or space may be customized to fit the player's head or the ECM. Alternatively, standard stock sized cavities may be desired. For example, the cavity size or space size may be 3.8″ Long×2″ Wide×0.58″ Thick. Alternatively, the cavity size or space may be 2.1″ Long×2.1″ Wide×0.58″ Thick. Standard stock sized cavities can be designated as x-small, small, medium, large, extra-large, and/or any combination thereof. Furthermore, the impact mitigation pads may comprise a pad that can be removably coupled within the cavity and that contain a volume of impact mitigation structures. The removal of the impact mitigation pad from the cavity can expose the cavity and ready the cavity for installation of an ECM. The protective enclosure may come with one cavity or a plurality of different cavities.

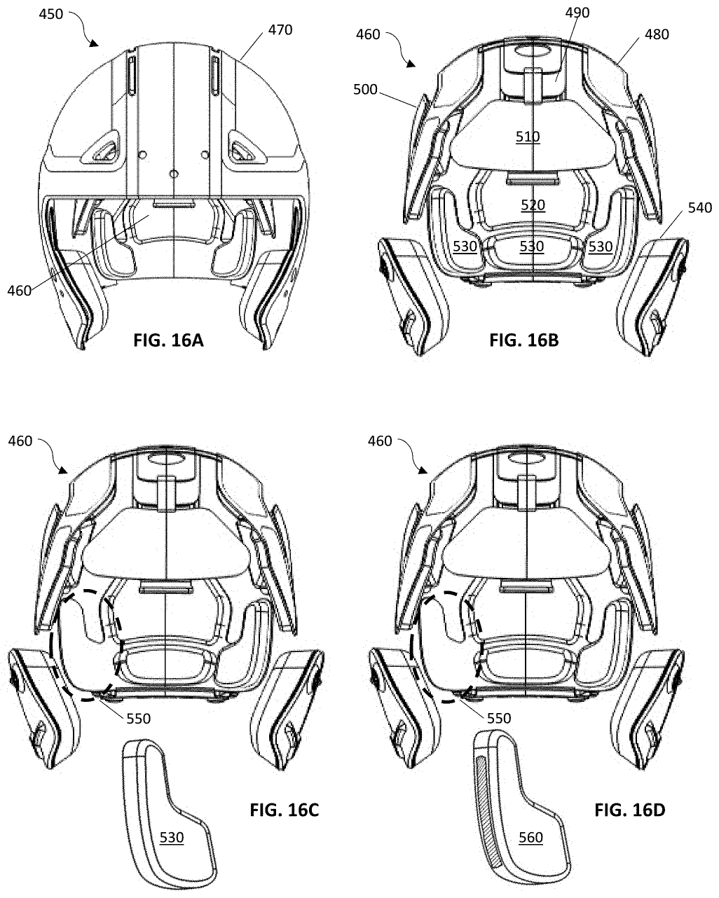

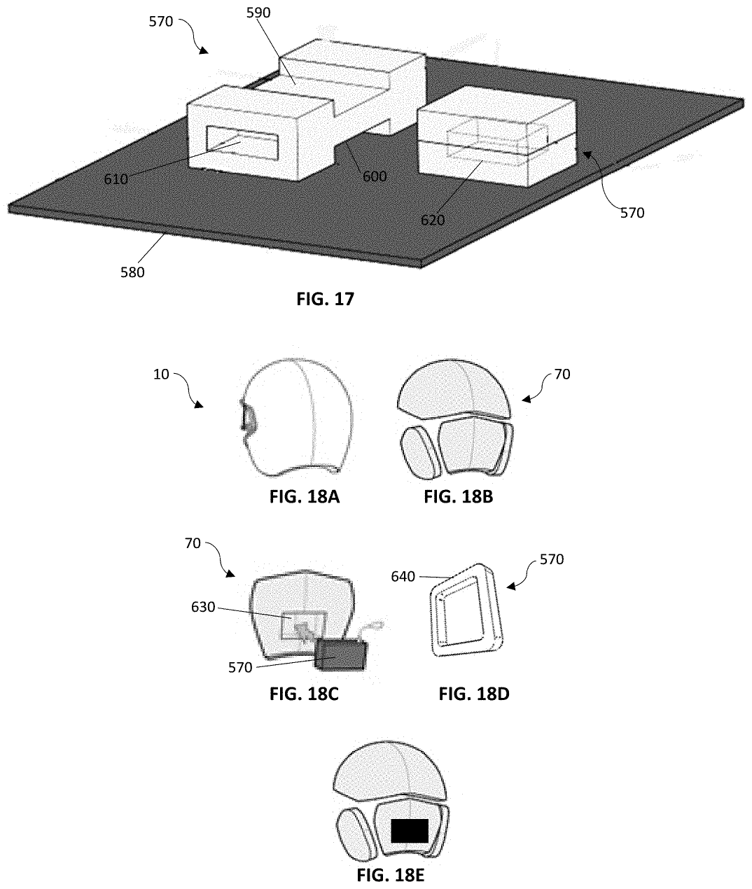

FIG. 17 illustrates various permutations of orientations where the cavity of the protective enclosure 570 may be accessed on a surface. The protective enclosure 570 having a cavity accessed from at least one inner or internal surface 590, outer surface 600, side surface 610, top surface, bottom surface, bisecting midplane 620, bisecting offset plane (not shown), and/or any combination thereof.

For example, as shown in FIG. 4B, a complete CA helmet 10 design may be separated into the main standard components, and the helmet structure assembly. The helmet structure assembly 20 can be further broken down into its specific components, such as the CA helmet comfort liner 50, the CA helmet outer layer 60, and the CA helmet Impact mitigation layer 70. As previously described herein, the regional location to retrofit a pocket or chamber within the impact mitigation layer 70 or the helmet comfort liner assembly 50 can be identified. FIGS. 18B shows that the lower back region was desired. At least a portion of the impact mitigation layer 70 and/or the helmet comfort liner assembly 50 (not shown) can be removed to create a pocket or chamber 630 where a protective enclosure 570 may be removably coupled or secured (see FIG. 18C). In one embodiment, the protective enclosure 570 may be removably coupled to the pocket or chamber 630 with the cavity access surface 640 faces towards the exposed internal surface, the internal surface may be in contact with and/or the cavity may be facing towards a portion of the comfort liner assembly or the player's head. Conversely, if the cavity could be accessed via the external surface (not shown), the external surface may be in contact with and/or the cavity may be facing towards helmet outer layer.

In another example, FIGS. 19A-19B shows that the jaw flap region 650 of the impact mitigation layer 70 was identified. Removal should take place to create a pocket/chamber and/or space/void. For example, at least a portion of the original jaw pad (not shown) can be removed create a space or void (see FIGS. 13A-13C and/or 16A-16D), where a replacement protective enclosure can be removably coupled. In addition, at least a portion of the impact mitigation layer from the jaw flap region 650 can be removed to create a pocket or chamber 630, where a protective enclosure can be removably coupled. Alternatively, at least a portion of the original jaw pad from the comfort liner assembly can be removed to create a pocket or chamber, the original jaw pad desirably creates a protective enclosure 570 that can be removably coupled or secured (see FIG. 19A). The protective enclosure 570 may be removably coupled to the pocket or chamber 630 with the cavity access surface 640 faces towards the internal surface as shown in FIG. 19B, the internal surface may be in contact with and/or the cavity may be facing towards a portion of the comfort liner assembly or the player's head. Conversely, if the cavity access surface 640 could face towards the external surface as shown in FIG. 19A, the external surface may be in contact with and/or the cavity may be facing towards helmet outer layer.

In another embodiment, the cavity may allow for a side facing surface 610, such as shown in FIG. 20, to place an ECM 660 or impact mitigation pad (not shown). Although, the top side surface was selected, any side face surface may be selected along the perimeter of the protective enclosure 570. For example, FIGS. 21A-21B shows that the jaw flap region of the impact mitigation layer 70 was identified. At least a portion of the original jaw pad (part of the comfort liner assembly) can be removed create a space or void (see FIGS. 13A-13C and/or 16A-16D), where a replacement protective enclosure is removably coupled and/or at least a portion of the impact mitigation layer from the jaw flap region can be removed to create a pocket or chamber where a protective enclosure can be removably coupled, and/or at least a portion of the original jaw pad as shown in FIG. 22A can be removed to create a pocket or chamber 680, allowing the ECM 660 to be disposed within the pocket or chamber 680, resulting In a modified jaw pad 670 that creates a protective enclosure. The modified jaw pad 670 protective enclosure can be removably coupled within the space/void and/or the pocket/chamber and/or be secured to the helmet outer layer as shown in FIG. 22B, the comfort liner assembly, and/or the Impact mitigation layer.

FIGS. 23, 24A-24B depicts another embodiment of retrofitting a CA helmet into an ECS helmet, by removing a portion of the impact mitigation layer to create a pocket or chamber, and removably coupling a protective enclosure. FIG. 23A shows a complete CA helmet 10 that has at least one impact mitigation layer 70. As previously described herein, the regional location to retrofit a pocket or chamber within the impact mitigation layer 70 or the helmet comfort liner assembly 50 should be identified. FIGS. 24A shows that the lower back region was desired. At least a portion of the impact mitigation layer 70 was removed to create a pocket or chamber 680. A protective enclosure 570 may be removably coupled within the pocket or chamber 680. The protective enclosure may have a cavity that can be accessed from any surface, including at least one inner or internal surface 590, outer surface 600, side surface 610, top surface, bottom surface, bisecting midplane 620, bisecting offset plane (not shown), and/or any combination thereof.

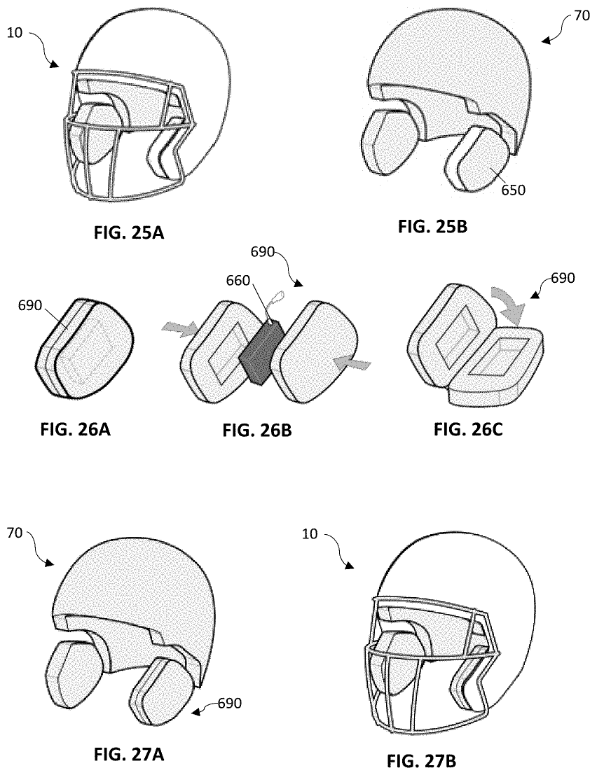

FIGS. 25A to 27B illustrate another embodiment of an ECM helmet with a protective enclosure that has a cavity accessed by a bisecting mid plane 570 and/or off-set plane (not shown), allowing access to a cavity within the body of the protective enclosure. In such embodiment as this, the two halves or pieces of the pad could be held together with Velcro, mechanical fasteners, magnetic fasteners, or other means of attachment. FIG. 25A-25B shows a complete CA helmet 10 that has at least one impact mitigation layer 70 or comfort liner assembly (not shown). As previously described herein, the regional location to retrofit a pocket or chamber within the impact mitigation layer 70 or the helmet comfort liner assembly 50 should be identified. FIG. 25B shows that the jaw flap region 650 of the impact mitigation layer 70 and/or the comfort liner assembly (not shown) was identified. Removal should take place to create a pocket/chamber and/or space/void. For example, at least a portion of the original jaw pad (not shown) can be removed to create a space or void where a replacement protective enclosure can be removably coupled (see FIGS. 13A-13C and/or 16A-16D). In addition, at least a portion of the impact mitigation layer from the jaw flap region can be removed to create a pocket or chamber, where a protective enclosure can be removably coupled (not shown). Alternatively, at least a portion of the original jaw pad from the comfort liner assembly can be removed to create a pocket or chamber, the original jaw pad creating a protective enclosure 690 that can be removably coupled or secured (see FIG. 26A). Such a bisecting mid-plane protective enclosure 690 may create a top portion and a second portion, where the top portion and the second portion may have at least one surface with a cavity disposed within, such as shown in FIG. 26A. The top and bottom portion of the protective enclosure can be removably coupled or have a fixed coupling. The coupling may occur via a hinge, a friction hinge, a pivoting hinge, and/or a flexible hinge, that can rotate in a particular axis so that the cavity is exposed when one or more portions are rotated in a particular fashion as shown in FIGS. 26B-26C. Alternatively, other mechanical coupling methods known in the art may be used, including friction, Velcro, mechanical fasteners, magnetic fasteners, or other means of attachment (not shown). The protective enclosure 690 may be removably coupled within the pocket or chamber and/or the empty space or void and/or secured to the helmet outer layer, the comfort liner assembly, and/or the Impact mitigation layer.

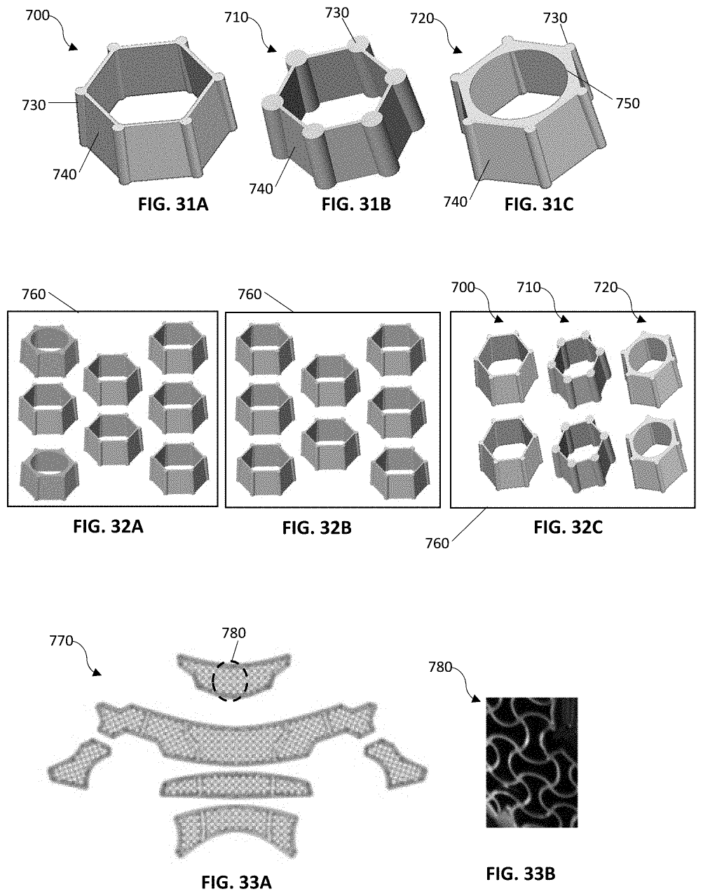

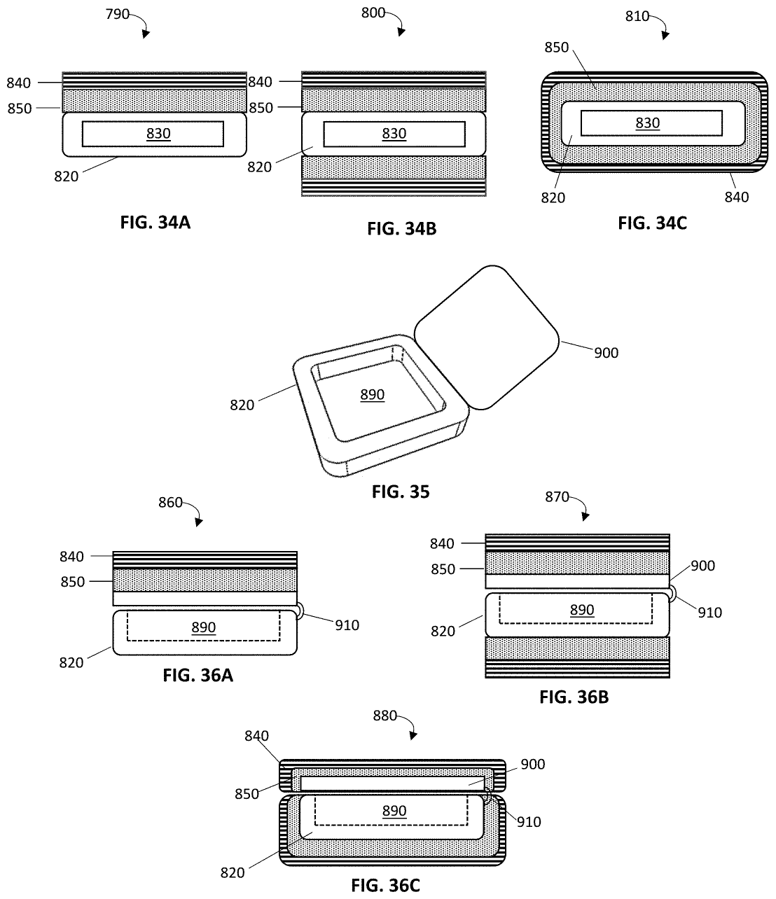

In another embodiment, the protective case may comprise a mitigation structure. The impact mitigation structure can be coupled to at least a portion of the base (see FIGS. 34A-34B) or surround the entirety of the base (see FIG. 34C). Such impact mitigating structures will desirably help absorb and dissipate the impact forces. The impact mitigating structures may include the same impact mitigating structure as used in the original CA helmet impact mitigation layer and/or it may be different than the original CA helmet impact mitigation layer. The impact mitigation structures may comprise a portion of at least one: filaments (see FIGS. 5A-5D), laterally supported filaments (see FIGS. 31A-31C and 32A-32C), auxetic structures (see FIGS. 33A-33B), impact foam or foam layer (see FIGS. 7A-7B), TPU cones (see FIGS. 6A-6B), inflatable bladders (see FIGS. 7A-7B), shock bonnets (see FIGS. 9A-9B), and/or any combination thereof.

In one embodiment, the impact mitigating structures can comprise at least a portion of filaments. FIGS. 5A-5D depicts that at least a portion of filaments may be thin, longitudinally extending members or be shaped and configured to deform non-linearly in response to an impact force. The non-linear deformation behavior is expected to provide improved protection against high-impact forces, and/or oblique forces. The non-linear deformation behavior is described by at least a portion of the filaments stress-strain profile. The non-linear stress-strain profile illustrates that there can be an initial rapid increase in force (region I) followed by a change in slope that may be flat, decreasing or increasing slope (region II), followed by a third region with a different slope (region III).

In another embodiment, the at least a portion of the filaments may comprise filaments that buckle in response to an incident force, where buckling may be characterized by a localized, sudden failure of the filament structure subjected to high compressive stress, where the actual compressive stress at the point of failure is less than the ultimate compressive stress that the material is capable of withstanding. Furthermore, the at least a portion of the filaments may be configured to deform elastically, allowing the at least a portion of the filaments to substantially return to their initial configuration once the external force is removed.

In another embodiment, the impact mitigating structures can comprise at least a portion of a plurality of filaments 730 that are interconnected by laterally positioned walls or sheets 730 in a polygonal configuration, otherwise known as laterally supported filaments (LSF) 700, 710, 720. FIGS. 31A-31C illustrate at least a portion of the LSF structures, where the filaments 730 are arranged in a hexagonal pattern interconnected by laterally positioned walls 740. Alternatively, other polygonal structures known in the art may be contemplated, such as triangular, square, pentagonal, hexagonal, septagonal, octagonal, and/or any combination thereof. A plurality of sheets or lateral walls can be secured between adjacent pairs of filaments with each filament having a pair of lateral walls attached thereto. In the disclosed embodiment, the lateral walls can be oriented approximately 120 degrees apart about the filament axis, with each lateral wall extending substantially along the longitudinal length of the filament. The shape, wall thickness or diameter, height, and configuration of the lateral walls and/or filaments may vary as shown in FIGS. 31A-31C to “tune” or “tailor” the structures to a desired performance. For example, one embodiment of a hexagonal structure may have a tapered configuration as shown in FIG. 31A. The hexagonal structure can have a top surface and a bottom surface, with the bottom surface perimeter (and/or bottom surface thickness/diameter of the individual elements) that may be larger than the corresponding top surface perimeter (and/or individual element thickness/diameter). In another example, the hexagonal structure can have an upper ridge 750 as shown in FIG. 31C. The upper ridge can also facilitate connection to another structure, such as an inner surface of a helmet, an item of protective clothing, and/or a mechanical connection (e.g., a grommet or plug having an enlarged tip that is desirably slightly larger than the opening in the upper ridge of the hexagonal element).

Furthermore, the polygonal or hexagonal structures may be manufactured as individual structures or in a patterned array. The individual structures can be manufactured using an extrusion, investment casting or injection molding process. Each individual polygonal or hexagonal structure may be affixed directly to a base in a custom location or pattern that may be arranged in continuous or segmented array. Also, they may have the same shape and configuration with repeating symmetrical arrangement or asymmetrical arrangement and/or different shape and configurations with repeating symmetrical arrangement or asymmetrical arrangement.

Conversely, the polygonal or hexagonal structures 700, 710, 720 may be manufactured directly into a patterned array that is affixed to at least one base membrane 760, such as shown in FIGS. 32A-32C. The base membrane may be manufactured with a polymeric or foam material. The polymeric or foam material may be flexible and/or elastic to allows it to be easily bent, twisted or flexed to conform to complex surfaces. Alternatively, the polymeric and/or foam material may be substantially rigid. The manufacturing of each patterned array of polygonal or hexagonal structures may include extrusion, investment casting or injection molding process. The base membrane with the polygonal or hexagonal structures may be affixed directly to at least a portion of the base or the entirety. Affixing each pattered array of polygonal or hexagonal structures may be arranged in continuous or segmented arrays. Also, the polygonal or hexagonal structures may have the same shape and configuration with repeating symmetrical arrangement or asymmetrical arrangement and/or different shape and configurations with repeating symmetrical arrangement or asymmetrical arrangement.

In another embodiment, the impact mitigation structure may comprise at least a portion of auxetic structures 770 as shown in FIG. 33A-33B. The auxetic structures 770 may include a plurality of interconnected members forming an array of reentrant shapes positioned on the flexible head layer. Such auxetic structures may be coupled or affixed to the protective enclosure base as a continuous layer or in segmented arrays. The term “auxetic” generally refers to a material or structure that has a negative Poisson ratio, when stretched, auxetic materials or structures become thicker (as opposed to thinner) in a direction perpendicular to the applied force. Such auxetic structures can result in high energy absorption and/or fracture resistance. In particular, when a force is applied to the auxetic material or structure, the impact can cause it to expand (or contract) in one direction, resulting in associated expansion (or contraction) in a perpendicular direction. It should be recognized that those skilled in the art could utilize auxetic structures, such as those shown in FIG. 33B, to include differently shaped segments or other structural members and different shaped voids. For example, FIG. 33B illustrates an amplified view of one embodiment of a auxetic structure 780 that is “bone” or “ribbon” shaped with radiused or arced re-entrant shapes.

In another embodiment, the protective enclosuremay comprise at least one covering. The covering may be coupled to at least a portion of the protective enclosure or the entirety of the enclosure. The least one covering may be a loosely or tightly woven fabric. The fabric may be polymeric, such as polypropylene, polyethylene, polyester, nylon, PVC, PTFE, and/or any combination thereof. The fabric may be 2-way or 4-way stretch material. Furthermore, the at least one covering may be breathable and wick away moisture easily from the skin while carrying out various sporting and athletic activities. For example, the covering may completely or continually cover an entire array of impact mitigating structures, such as shown in FIG. 34. Conversely, the covering may cover at least a portion of an entire array of impact mitigating structures (see FIG. 34A-34B).

For example, FIG. 34A-34B Illustrates a cross-section view of one embodiment of a protective enclosure including impact mitigation structures and/or a covering 790, 800, 810. The protective enclosures 790, 800, 810 may comprise at least one base 820 with a side access cavity 830. At least a portion of the base 820 may comprise an impact mitigation structure 850 and/or a covering 840. Alternatively, the entirety of the base 820 with a side access cavity 830 may be enclosed—i.e., the entire perimeter of the base as shown In FIG. 34C.

FIGS. 35 and 36A-36C illustrates cross-section views of other embodiments of various protective enclosures including impact mitigation structures and/or a covering 860, 870, 880. The protective enclosures 860, 870, 880 may comprise at least one base 820 with a top, bottom, inside and/or outside access cavity 890, at least one a lid or a second portion 900, the lid or the second portion 900 may have an additional cavity of a different or same size and configuration as the base 820, the at least one lid or second portion 900 may be coupled to the base 820 with at least one hinge 910. At least a portion of the base 820 may comprise an impact mitigation structure 850 and/or a covering 840 as shown in FIG. 36A and 36B. Alternatively, the entirety of the base 820 with a top, bottom, inside and/or outside cavity 890 may be enclosed—i.e., the entire perimeter of the base as shown In FIG. 36C.

In another embodiment, the protective enclosure 860, 870, 880 may come equipped with other features. Such features may include at least one of a pull-tab or other mechanism known in the art to facilitate easy removal of the protective enclosure from the chamber or pocket, wireless charging for the ECM battery, speaker, through-holes for easy attachment and transport, logos, and/or any combination thereof.

Impact Mitigation Pad

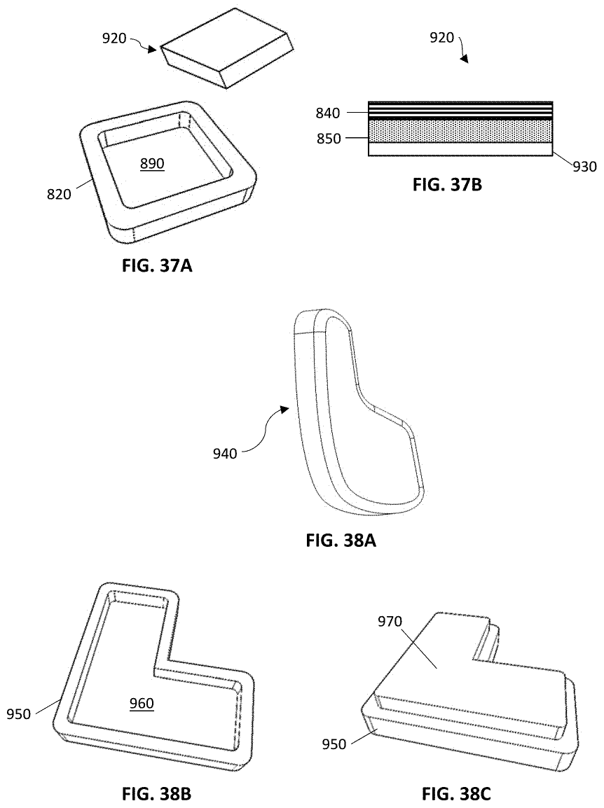

In one embodiment, an impact mitigation pad 920 may be removably coupled to the cavity 890 within the protective enclosure base 820. Such impact mitigation pads may be custom-fitted to the player's individual needs or they may be stock pads that are available in different thicknesses, impact protection, comfort, and/or any combination thereof. FIG. 37B depicts a cross-section view of one embodiment of an impact mitigation pad 920. The impact mitigation pad 920 may comprise at least one base 930, at least one impact mitigation structure 850, at least one covering 840, and/or any combination thereof.

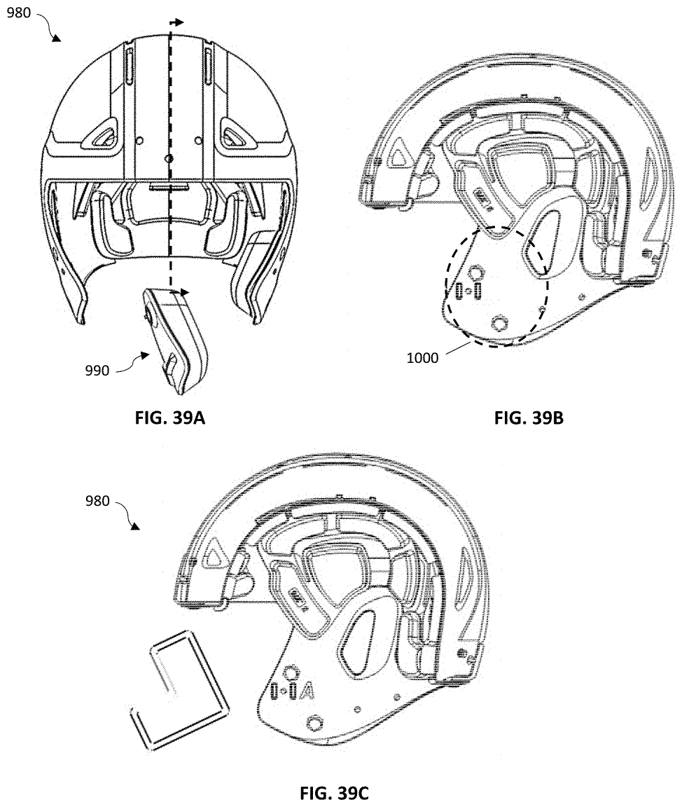

In another embodiment, the impact mitigation pad 940, 970 may also have a custom shape to be removably coupled the protective enclosure base 950 within a cavity 960. FIGS. 38A-38C depict various embodiments of a custom shaped impact protection pad 940, 970. The custom shaped impact mitigation pad 940, 970 may be available in different thicknesses, impact protection, comfort and/or any combination thereof. The custom protective enclosure can replace a portion of a comfort liner assembly as shown in FIGS. 39A-39C. For example, at least a portion of the comfort liner assembly 990, as shown in FIG. 39A, may be removed from the CA helmet 980, leaving an open space or void 1000. A protective enclosure comprising at least one base 950 and at least one impact mitigation pad 970, 940 can be removably coupled to the empty space or void 1000, such as shown in FIG. 39C. The protective enclosure with the impact protection pad can now expand impact protection from the jaw to the temple—providing substantially more surface area along the face for protection. Alternatively, such a custom shape may be designed to accommodate usual shapes for removably coupling within a portion of the impact mitigation layer.

As previously disclosed herein, the impact mitigation structures may comprise a portion of at least one of: filaments (see FIGS. 5A-5D), laterally supported filaments (see FIGS. 31A-31C and 32A-32C), auxetic structures (see FIGS. 33A-33B), impact foam or foam layer (see FIGS. 7A-7B), TPU cones (see FIGS. 6A-6B), inflatable bladders (see FIGS. 7A-7B), shock bonnets (see FIGS. 9A-9B), and/or any combination thereof.

General Electronic Communications Modules (ECM)

As disclosed herein, it may be desirable to place an ECM into a protective enclosure and removably couple the protective enclosure to various regional locations within the CA helmet to allow quick removal and provide impact protection to the player. The CA helmet may be retrofitted to removably couple a protective enclosure. Retrofitting a CA helmet may use the methods disclosed herein to accommodate the protective enclosure. Retrofitting may include at least one of (1) removing a portion of a comfort liner assembly to create an empty void or space, which a protective enclosure is removably coupled onto the empty space or void; (2) removing a portion of an impact mitigation layer to create a chamber or pocket, which the protective enclosure can be removably coupled; and (3) removing at least a portion of a comfort liner assembly to create a pocket or chamber within the at least a portion of a comfort liner assembly to create a protective enclosure, and/or (4) removably coupling the at least a portion of the modified comfort liner assembly. Alternatively, any ECM can be placed directly within the CA helmet outer layer, impact mitigation layer, the comfort liner assembly, and/or any combination thereof.

An ECM may comprise one or a plurality of electronic modules. The electronic modules may comprise any electronic modules that are capable of communications, video or image displays, data processing, storing data, transmitting data and/or utility. Such electronic modules may include one or more of a heads-up displays (HUD), a head-mounted displays (HMD), computer processing units (CPUs), optical communication systems, radio communication systems (e.g., one-way communication and/or two-way communication systems), full duplex communication systems, half-duplex communication systems, tactile communication systems, digital communication systems, power supplies (non-rechargeable or rechargeable), speakers, projector unites, microphones, any portable electronic devices (e.g., mobile phones, tablets, laptops, e-readers, MP3 Player, personal digital assistants (PDA), etc.), and/or any combination thereof.

Example Embodiments—Heads-Up Display

A Heads-Up Display (HUD) may comprise one embodiment of an ECM. A HUD may be any transparent display and electronic equipment that presents data without requiring users or players to look away from (or only slightly alter a point of attention or focus from) their usual viewpoints. The HUD (e.g., the projection apparatus and associated components) disclosed herein may be integrated or retrofitted into a commercially available (CA) athletic helmet, which desirably operate to produce a heads-up display in the CA helmet by interacting with a protective visor positioned proximate to and/or within the face shield of the helmet to transmit and/or reflect the projected information to the eyes of the wearer.

Due to the plurality of the associated components within a HUD, it may be desirable to place the HUD within at least one protective enclosure, and removably couple it to various regional locations within the CA helmet. The CA helmet may be retrofitted using the methods disclosed herein to accommodate the protective enclosure. Retrofitting may include: (1) removing a portion of a comfort liner assembly to create an empty void or space, which a protective enclosure is removably coupled onto the empty space or void; (2) removing a portion of an impact mitigation layer to create a chamber or pocket, which the protective enclosure can be removably coupled; and (3) removing at least a portion of a comfort liner assembly to create a pocket or chamber within the at least a portion of a comfort liner assembly to create a protective enclosure, and/or (4) removably coupling the at least a portion of the modified comfort liner assembly. Alternatively, the HUD or any other ECM can be placed directly within the CA helmet outer layer, impact mitigation layer, the comfort liner assembly, and/or any combination thereof.

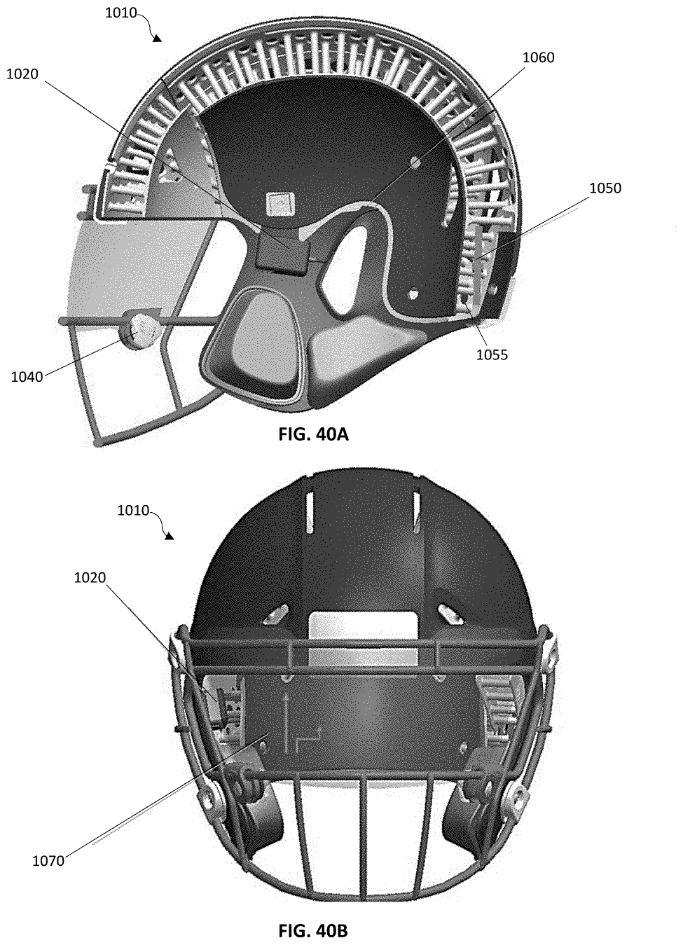

In one exemplary embodiment, a commercially available (CA) helmet 1010 may be retrofitted to include a HUD as shown in FIG. 40A, the HUD may comprise a at least one projector unit 120, 1040, at least one combiner 1070 (e.g., display using a protective visor), at least one a computer 1050, and/or any combination thereof.

In various exemplary embodiments, the protective visor can desirably function as a “combiner” or semi-reflective surface, allowing the virtual information to be projected on a transparent visor screen so that the information appears to be floating in space as a virtual image (including the presentation of two dimensional and/or three-dimensional images or other information, if desired). In other exemplary embodiments, the protective visor can display and/or transmit information to the eye of the wearer, while in still other exemplary embodiments, a projector or similar device could be provided that is capable of transmitting information directly to one or more eyes of the helmet wearer.

In various embodiments, the heads-up display within the helmet is designed to provide a display at a sufficiently high intensity such that it can be viewed with a neutral density (anti-glare) visor, which may have a transmission value of approximately 16 percent. However, a combiner could alternatively include a coating or otherwise possibly attenuate one or more signals within the particular waveband(s) to which it is tuned, especially where multiple combiners (i.e., holographic combiners) may be incorporated into a single display visor. Where such specialized tuning is utilized, the transmission value of the anti-glare visor within the selected waveband could be increased and/or decreased, as desired.

In various alternative arrangements, a protective football visor can comprise a transparent plastic or glass material having include a neutral-color, thin-film interference coating, which could desirably increase the reflectivity of the visor to 23% (and which in turn reduces the visible transmission through the combiner to 77%). The transmitted view will desirably be color-neutral, while the virtual display image could be almost any shade or color, including full-color images as well as monochromatic images such as those derived from a cathode-ray tube (CRT) or similar projector/transmitter (i.e., green, where the human eye can be most sensitive). To work effectively, information from the virtual image in head-up displays will desirably be visible in a variety of conditions—the display will desirably be sufficiently visible to contrast with the ground, the playing field, other players, the ball (i.e., the football) and/or the background sky in bright cloud, sunlight and/or artificial lighting conditions (i.e., during night games)—which may include dynamic changes of the color and/or intensity of the display to accommodate varying backgrounds during play.

Because weight and safety are of paramount importance for a protective visor in a helmet, the use of a plastic combiner visor may be particularly desirable. For example, a single-notch rugate filter on a polycarbonate football helmet visor for a helmet-mounted display can desirably provide an extremely rugged and useful HUD system, and the use of multiple-notch coatings for visors and plastic combiners are specifically contemplated herein. In various embodiments, dual-graded combiners for three-color displays could be incorporated in a helmet, including the employment of triple-notch graded rugate coatings in which the notch depth progressively decreases over the grade to become an antireflection coating. In various sports applications, a multiple-color display could potentially enable information and/or “warning” indicators to attract player attention sooner than a monochromatic display, including the use of narrow-bandwidth color light engines and multiple-notch combiners.

In various embodiments, the protective visor will desirably comprise an impact resilient plastic structure, which may be curved to follow the contours of the helmet and/or the facemask and/or the user's face. Alternatively, the protective visor may comprise a more flattened or gently curved planar structure, but the visor will desirably be positioned in a location relative to the helmet to desirably ensure that helmet impacts do not cause the visor to strike the player's face and/or features with excessive force. If desired, the visor may comprise a relative thick structure (i.e., greater than 0.25″ in thickness), which may be easier to shape and/or curve than thinner structures where the visor incorporates or comprises an Organic Light Emitting Diode OLED or similar screen.

In at least one exemplary embodiment, a HUD apparatus and associated components can include a protective visor positioned proximate to and/or within the face shield of the helmet, at least a portion of the protective visor comprising a transparent (OLED) display, which can optionally include a curved surface that approximates and/or mimics the curvature of the face shield and which could be attached to various locations on the face shield and/or helmet body. In various alternative embodiments, an OLED display could comprise the entire face shield of the helmet (if constructed of sufficiently strong and/or thick layers of material it may even replace and/or augment traditional facemask bars), which could include attachment points proximate to or within the face opening of the helmet. In at least one additional alternative embodiment, the OLED display could encompass more than just the face opening of the helmet, which could include an OLED display which extends and/or wraps around some portion and/or all of the wearer's head, potentially including a helmet design including an outer OLED display surface forming the outer surface of the helmet, with a transparent “window” portion in the OLED display that accommodates the athlete's face (i.e., to allow the athlete to see through the transparent “window”) with the remainder of the helmet surface available for graphics and/or other visuals (i.e., to present advertising or sponsor visuals, or to identify radio communications capability and/or to indicate eligible football receivers on the field, etc.), in which these additional graphics and/or other visuals may or may not be visible to the helmet's wearer, and the “window” providing HUD information to the wearer as described herein.

Various aspects of the present invention, or any parts or functions thereof, may be implemented using hardware, software, firmware, non-transitory tangible computer readable or computer usable storage media having instructions stored thereon, or a combination thereof, and may be implemented in one or more computer systems or other processing systems. More particularly, embodiments of the present invention relate to systems and methods for wearable electronic devices, including devices and systems for presenting computer-generated sensory input via a HUD to an individual engaged in or observing an athletic activity, based on data related to the athletic activity. In various embodiments, an individual engaged in an athletic activity or an interested observer, such as a coach or fan, may desire to receive information about an athletic activity, including information about the individual's performance during the athletic activity.

In at least one exemplary embodiment, the helmet HUD may communicate with a wireless wide area network communications system such as that employed by mobile telephones. For example, a wireless wide area network communication system may include a plurality of geographically distributed communication towers and base station systems. Communication towers may include one or more antennae supporting long-range two-way radio frequency communication wireless devices, such as one or more helmet HUD systems. The radio frequency communication between antennae and the HUD may utilize radio frequency signals conforming to any known or future developed wireless protocol, for example, CDMA, GSM, EDGE, 3G, 4G, IEEE 802.x (e.g., IEEE 802.16 (WiMAX)), etc. The information transmitted over-the-air by the base station systems and the cellular communication towers to the HUD may be further transmitted to or received from one or more additional circuit-switched or packet-switched communication networks, including, for example, the Internet.

Example Embodiments—Placement of HUD within CA Helmet

In various embodiments, a HUD projection apparatus and associated components are disclosed that can be integrated into a protective CA helmet, such as a football helmet, by using at least one protective enclosure. One embodiment of the football helmet can include one or more removable protective enclosures that may be integrated within the impact mitigation layer of a CA helmet.

Alternatively, one or more components of the HUD systems described herein could be positioned in and/or located at non-CA helmet locations on a wearer's/player's body, such as battery packs, GPS sensors, antennas/transmitters and/or computing components being disposed and/or formed within protective pads (i.e., shoulder or shin or thigh pads) or other articles worn on other locations of the player's body. In such cases, there may be a need for additional wired and/or wireless connections between these components and the associated HUD or other components in the wearer's helmet

Such protective enclosures can be made of different structures, including a base, impact mitigation structures (such as buckling columns, laterally supported polygonal support structures such as hexagons, TPU cones, foam, elastomeric material, air, and/or any combination thereof), and/or a lid. Desirably, the protective enclosures can be house a variety of ECMs, such as including (but not limited to) components such as power supplies (i.e., battery packs), video and/or computing resources (i.e., microprocessors and/or memory resources), radio transmitters and/or receivers and/or camera and/or image projection devices. Where possible, the replacement components will desirably comprise low-profile, soft and/or flexible constituents and/or devices, such as flexible batteries (BrightVolt™ conformal batteries commercially available from BrightVolt of Redmond, Wash., USA) and/or similar components. Computing connections between the various components can be wired and/or wireless, including the use of Bluetooth TCP/IP, IEEE 802.16, Bluetooth low energy, ANT, ANT+ by Dynastream Innovations, BlueRobin, or similar communications technologies, if desired.

Where a protective enclosure incorporates a component of the HUD system, the replacement impact mitigation pad may optionally include one of more impact absorbing structures adjacent to the component as part of the pad body. For example, a replacement impact mitigation pad may incorporate a supplemental foam or reflex layer next positioned adjacent and/or next to the relatively harder HUD component, with the impact absorbing structure layer positioned between the wearer's head and the HUD component (to desirably protect the wearer from impact with the component, for example). In such a case, the foam or impact absorbing structure layer may be “stiffer” or provide additional resistance to impact to some degree than the remainder of the helmet protective layers (or the layer may be softer than surrounding helmet layers, in some embodiments). Alternatively, and/or in addition to the inner supplemental layer, the replacement impact mitigation pad may incorporate an outer supplemental foam or impact absorbing structure layer next to or adjacent to the relatively harder HUD component, with the impact absorbing structure layer positioned between the HUD component and the outer helmet layer (to desirably protect the component from external helmet impacts, for example). In such a case, this outer supplemental foam or impact absorbing structure layer may be “softer” or provide less resistance to impact to some degree than the remainder of the helmet protective layers (or this layer may be harder than surrounding layers, in some embodiments).

If desired, the protective enclosure can come equipped with removably coupled impact mitigation pad. Once the equipment manager designates the players that will carry the HUD and its associated components, the equipment manager may remove the impact mitigation pad and replace it with an ECM or a HUD and its associated components. The impact mitigation pad may be positioned over the ECM to act like a “lid” or cover. Then the protective enclosure can be re-inserted into the CA helmet in its designated locations.

As previously disclosed herein, the protective enclosure can comprise one or more segments of individual impact mitigation pads held within an outer shell, which can be placed in a designated impact mitigation layer cavity by sliding it from the edge of the helmet, placing it from the inner side of the helmet, or placing it within the impact mitigation layer through removal of a cavity “lid” or “cover”. In certain embodiments, the protective enclosure can be affixed to the surrounding structure/material with Velcro, mechanical fasteners, magnetic fasteners or slid into place so that it is securely held.

In various embodiments, at least a portion of the impact mitigation layer, at least a portion of the comfort liner assembly, or another helmet component could be removed and replaced by one or more ECMs. For example, a replaceable protective enclosure could include a portion that is adjacent to and/or which replaces a portion of an outer structure or outer layer of the CA helmet. For example, an occipital pad on the rear of a helmet may include a camera or other component which extends outside of and/or through an opening in the outer helmet body or outer layer (or which abuts the surface of the CA helmet, but does not extend fully therethrough). Such a camera could be extremely useful to the wearer to monitor “blind spots” around the player, such as rearward facing activities and/or the player's “blindside,” which could include a live feed to the HUD helmet display of the activity occurring rearward of the helmet. Currently, it is common practice for receivers and other players on the field to periodically watch the large stadium displays (i.e., the “Jumbotron”) during breakaway running to monitor pursuit activities by players behind them—a practice which could easily be duplicated on an individual basis using various components with the present HUD system.

For example, FIGS. 40A and 40B illustrate one embodiment of a CA helmet that may integrate protective enclosures that house the ECM (or HUD and its associated components). The CA helmet 1010 comprises a HUD, the HUD comprises a projector 1020, a project clip 1040, a computer 1050, a combiner or protective visor 1070 and the wired route 1060. FIG. 40A illustrates that at least a portion of the impact mitigation layer 1055 was removed at the lower-back region to create a pocket or chamber. At least one protective enclosure may house the computer, where the at least one protective enclosure can be removably coupled within the impact mitigation layer 1055 pocket or chamber. The wire from the computer may extend from the at least one protective enclosure. In addition, a second protective enclosure may be used to house the projector unit 1020. The second protective enclosure may be removably coupled to an area that is adjacent to the ear flap and jaw flap region. The wire route 1060 may travel adjacent to the ear flap and the jaw flap region 1060.

The various embodiments described herein will desirably provide a player with a seamless experience on the field, and obviate the player's need to look away from a specific area in the field of activity in order to view an informational output (e.g., a visual indicator of the individual's heart rate or the speed of a ball kicked by the individual), which desirably maintains a proper level of attention, awareness, and concentration by the player on the athletic activity. In the context of an ongoing competitive session (e.g. a football or soccer match), this prevents a drop in the individual's performance during the inattentive moment and/or possible risk of injury to a distracted individual. Even in the context of a more informal non-competitive training session (e.g. conducting football or soccer drills), the distraction from having to look away from the individual's usual viewpoint can slowdown and therefore lengthen the training session and/or “pull” the individual out of their training “flow,” possibly reducing the overall effectiveness of the training session. Desirably, the HUD systems and associated components described in various embodiments of the invention may superimpose graphics, audio, and other sensory enhancements over a real-world environment, most desirably in real time. Such HUD systems may incorporate display technology that is capable of projecting one or more images in a way that makes them visible and overlaid on top of the individual's “real world” view of their environment.

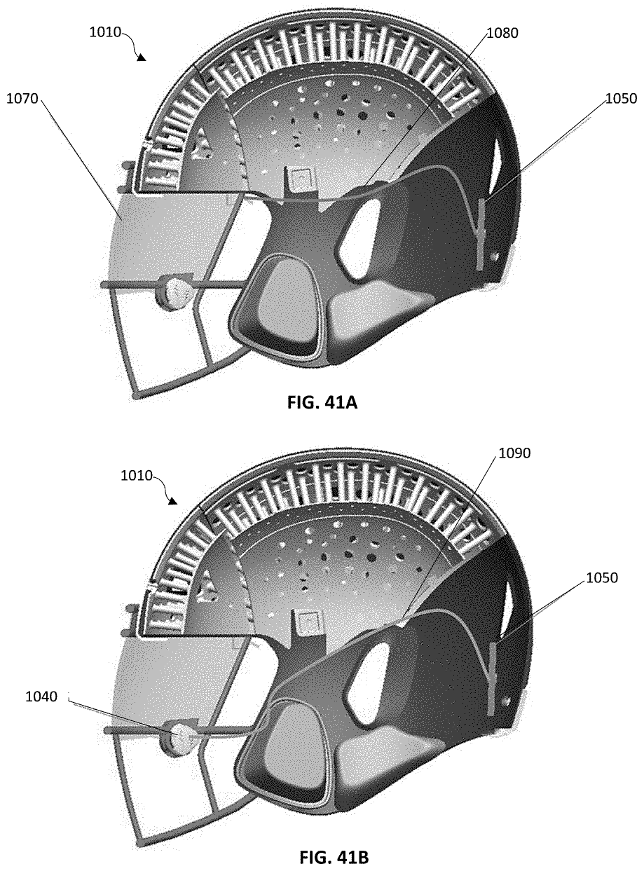

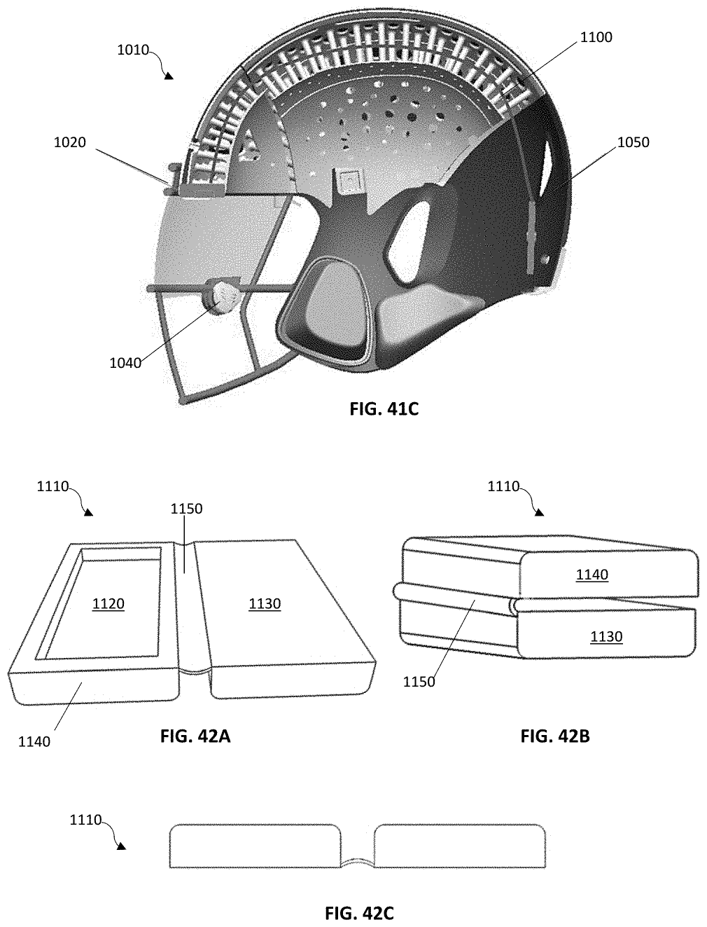

In various exemplary embodiments, a helmet can include a protective polycarbonate or other plastic visor positioned within a “face opening” of the helmet, with the visor desirably functioning as a “combiner” or semi-reflective surface, allowing virtual information to be projected and/or reflected on the transparent visor screen so that the information appears to the wearer to be floating in space as a virtual image (see FIGS. 40B and 41A). In other exemplary embodiments, a projector or similar device could be provided that is capable of transmitting information directly to one or more eyes of the helmet wearer.

As another alternative, the protective visor could alternatively display and/or transmit information to the eye(s) of the wearer (i.e., via an OLED visor), which may not require the use of a separate projector or similar device. For example, a HUD system in a CA helmet could include a combiner and an information generating device or other processing resources, wherein the image is produced directly in the combiner. The combiner can comprise, e.g., a liquid crystal display (LCD), a light-emitting diode (LED) display, or an organic light-emitting diode (OLED) display, optical waveguide, an electro-optical medium, or some other suitable medium for producing an image, which in various embodiments would desirably include a transparent portion of the display to allow the wearer to perceive the surrounding environment and field of play therethrough. Similar to the other combiner embodiments described herein, the size, shape, and placement of the combiner and related components described herein relative to the remaining helmet components can vary, as desired, including having a display size that can alter in size and/or location.

In various embodiments, a projector 1020, projector clips 1040 or similar device can be positioned within the helmet (see FIGS. 40A-40B, and 41B), such as proximate to one or more of the forehead, temples, ears and/or the temporomandibular joint(s) of the wearer. If desired, the projector 1020 could be attached and/or otherwise tethered to an inner surface of the helmet as shown in FIG. 40A-40B) or placed into a protective enclosure where the protective enclosure is removably coupled to an inner surface of the helmet, the face mask, and/or the chin strap or other locations, with the projector in some embodiments comprising an individual component while in other embodiments the projector could be embedded and/or attach to an impact absorbing and/or mitigation structure such as a cheek or jowl pad. If desired, two or more (i.e., a plurality) of projectors could be provided within a single helmet, including the positioning of one projector on each side of the wearer's head (i.e., proximate to the each of the wearer's temples), wherein each projector could provide an individual image on a separate portion of the display visor (or other screen), and/or the two projectors could provide images to an overlapping region of the display, such as wherein the displayed images could selectively be merged and/or appear individually on some portion and/or all of the visor.

In various embodiments, a power supply or power source such as a battery pack or similar component can be provided that fits within a space within the helmet or within a protective enclosure, such as a space vacated by one or more of the previously noted removable impact mitigation pads in the helmet. The power source may be built into the HUD or removable from the HUD, and may be rechargeable or non-rechargeable. In one embodiment, the HUD may be repowered by replacing one power source with another power source. In another embodiment, the power source may be recharged by a cable attached to a charging source, such as a universal serial bus (“USB”) FireWire, Ethernet, Thunderbolt, or headphone cable, including a cable attached to a personal computer or other power supply. In yet another embodiment, the power source may be recharged by inductive charging, wherein an electromagnetic field is used to transfer energy from an inductive charger to the power source when the two are brought in close proximity but need not be plugged into one another via a cable. In some embodiments, a docking station may be used to facilitate charging.

Desirably, the power supply will include one or more wired connections that can be connected to other components, which may include wires positioned within the inner surface of the helmet, within the impact absorbing or impact absorbing structure layer and/or between pads or other impact layers. For example, FIG. 41B shows the wire route 1090 to travel adjacent of the ear flap region and the jaw flap region towards the facemask, where the wire may be removably coupled to the facemask. Alternatively, FIG. 41C shows the wire route 1100 travelling through the impact mitigation layer to reach the front region of the helmet where the wire is coupled to the projector 1020. It's possible that the wire route may vary depending on the configuration of the helmet. Alternatively, the connection may be wireless.

Where the impact absorbing structures of the helmet incorporate impact absorbing structure layers including buckling structures and/or similar filament-based impact absorbing structures (including laterally-supported filaments and/or polygonal support structures such as hexagonal impact structures), these wires can easily be routed through and/or around the individual filaments/structures in the impact absorbing structure layer without significantly impacting the performance of such impact absorbing structures, greatly simplifying the assembly and maintenance of the HUD system. Alternatively, various wires and/or other connections may extend and/or be positioned outside of the helmet, or various combinations thereof. In various embodiments, removeable and/or replaceable wiring connections could be provided for a variety of components, including between various modular helmet components.

In various embodiments, a computing component will be provided that comprises a video and/or computer processing unit, which desirably provides image information to the projector, OLED screen and/or other display device within the helmet. If desired, the computing component could comprise a “static” unit that contains stored information that is processed and/or transmitted to the display unit in a variety of ways, or the computing component could comprise an interactive or dynamic computer and/or video processing unit that could be capable of processing external inputs and/or modifying the displayed information based on a variety of external and/or user controlled factors. For example, the computing component could include a memory component wherein a series of pre-loaded initial plays are loaded for the beginning of a football game, with each of these plays presented to the player through the display device during the “huddles” between plays. The memory of the HUD may similarly be adapted to store application program instructions and/or to store athletic activity data from player activity during the football game. In one embodiment, the memory may store raw data, recorded data, and/or calculated data. In some embodiments, the memory may act as a data storage buffer. The memory may include both read only memory and random access memory and may further include memory cards or other removable storage devices.

In various embodiments, the computing component could include a connection to one or more external inputs, which could include environmental and/or player inputs that could be processed to alter some or all of the presentation on the display device. For example, the HUD system or other device could provide the user with a “projection keyboard” or similar display feature, with icons or letters (or other selections) being projected onto the HUD display and/or other surface (including projections appearing to be on one or more “virtual surfaces” within the HUD display. The system could further incorporate sensors to determine selection or “activation” of the icon or letter, including visual or other sensors to determine the location of a wearer's fingers. Alternatively, the HUD display could include a touch-sensitive inner and/or outer surface to accommodate selection and/or activation by a wearer.

In at least one exemplary embodiment, a HUD system could display a series of selectable icons on an inner surface of the protective visor (which would desirably be visible to the wearer of the helmet), and the wearer could touch or position a finger (or other extremity) proximate to at least one icon at a corresponding location outside of the protective visor. Desirably, the HUD system could include a camera or other sensor that can interpret the wearer's outside finger movement as selecting or otherwise activating the icon in a specific manner (including gesture based movement such as curling or “scrolling” with one's finger to scroll through a series of selectable icons, or “sweeping” of a hand to either side to change a HUD display screen). In various embodiments, the icon could appear to be floating in the virtual environment, while in other embodiments the HUD system may “link” a specific icon to the outside environment, where movement of the user's head would not affect the position of the icon relative to the surrounding environment (i.e., the icon could appear to be on the playing field or ball, with the system maintaining the icon in a specific location in the environment, even where the helmet and visor were moved and/or rotated).

In even further embodiments, a wired and/or wireless receiving/transmitting device could be attached or otherwise linked to the computing component, with data transmission to and/or from the computing component and one or more external sources. For example, communication may also occur between the HUD system, and one or more other computing devices such as other Helmet HUD systems worn by other players, a server, a mobile phone, a body-mounted device, a ball-mounted device, and/or a coach device via a network. In at least one embodiment, the network can be a local network located within a sports stadium, while in another embodiment it may be the Internet. The Internet is a worldwide collection of servers, routers, switches and transmission lines that employ the Internet Protocol (TCP/IP) to communicate data. The network may also be employed for communication between any two or more of the HUD systems, server, a mobile phone, a body-mounted device, a ball-mounted device, and/or a coach device.

In various embodiments, the HUD system could include a communication device or radio to communicate via, e.g., a wireless network or a wired network, with other components, including other helmet components, other helmet systems and/or wearable components on the wearer or other team members. The wireless network could operate using, e.g., Bluetooth, WiFi (IEEE 802.11) or some other wireless protocol. In some embodiments, the HUD system could incorporate one or more other additional sensors. For example, in some embodiments, the HUD may include one or more of an acceleration sensor, a heart rate sensor, a magnetic field sensor, a thermometer, an angular momentum sensor (e.g., a gyroscope), and a positioning system receiver. In other embodiments, one or more of these sensors may be omitted, or one or more additional sensors may be added. If desired, the HUD could provide the wearer and/or an external monitoring station (i.e., a coach's or team doctor's station) with user-specific physical information such as player body temperature, blood O₂ saturation, heart rate, skin conductivity and/or blood pressure, as well as more generalized information such as player direction, speed, orientation and/or acceleration/deceleration during movement and/or tackling. Various embodiments could also include eye monitoring and/or tracking systems, including systems capable of detecting abnormal eye tracking by a player, which may be an indication of a potential concussion or other health issue requiring further monitoring and assessment. Such information could be provided real-time to a player's sideline coaches, or the HUD system could provide such information after an active play has ceased (i.e., between football “downs,” for example). Such information might be extremely useful to the coaches and/or team doctor in order to make player condition assessments before starting the next play on the field.

In one exemplary embodiment, a football helmet will incorporate a head-up display (HUD) for the wearer. In some embodiments, the HUD includes a projector, a combiner, and an information generating system or other computing system. The projector can be, e.g., an LED array, an LCD display, a laser, a combination LED/LCD system, or some other suitable projector system. In this embodiment, the projector projects an image onto the combiner. The image can be in the form of text, graphics, video, etc. The projector receives image information, e.g., in the form of a digital signal, from information generating device. The information generating device generates and/or processes the image based on information received from a computer system or from an external source (i.e., via radio from an external information source). This information can include a wide variety of topics, including current weather conditions on the field, opposing and/or same team player identification, play choices and/or running patterns, play information (i.e., game time remaining, play countdown clock, down, ball position and/or remaining yards for first down), etc. In some embodiments, the projector and information generating device can be integrated into a single physical unit. In some embodiments, the computer system can generate and/or process image(s) and transmit the image information directly to projector, which could include and/or be connected to a wireless communication device.

In various embodiments, the combiner will receive image information, e.g., in the form a digital signal, from the computing component and/or some other information generating device, which generates and/or processes the image based on information received therefrom. In some embodiments, the combiner and the information generating device could be integrated into a single physical unit. In some embodiments, the combiner and projection lens could be integrated into a single physical unit. In some other embodiments, the combiner, information generating device, and projector could be integrated into a single physical unit. In some embodiments, the computer system may generate and/or process the image and transmit the image information directly to combiner, which can include or is connected to a wireless communication device. In some embodiments, a combination camera and projector may be provided in the helmet, which may be similar to the OmniTouch camera/projector system developed by Carnegie Mellon University and Microsoft research.

In some embodiments, the combiner will desirably collimate the reflected image such that the projected image appears to be at a desired distance from the wearer, such as (1) adjacent to and/or next to the wearer's face or body, (2) at approximately five feet from the wearer, (3) at approximately 10 feet from the wearer, (4) at approximately 10 yards from the wearer, (5) at approximately 25 yards from the wearer, (6) at approximately 50 yards from the wearer, and/or (7) at optical infinity. Desirably, this collimation distance may coincide with the wearer's current activity focus, to obviate a need for the wearer to refocus to see both the external field activity and the projected image—especially during active play. If desired, the HUD system could include one or more cameras or other systems that could monitor player focus and modify the collimation distance to approximate the player's current focal length and/or attention location, and/or the system could remove the information from the display screen when the player focuses away from a desired “distance” and/or location area on the display visor (i.e., removing displayed information from the visor while a receiver is attempting to catch a thrown football).

In some embodiments, the combiner 134 is an appropriate transparent material, e.g., a curved and/or flattened piece of plastic and/or glass, that is angled and/or positioned such that the projected image from the projector is reflected to the wearer. In some embodiments, the mounting of the projector and/or combiner (i.e., visor) to the football helmet could be manually and/or automatically adjustable, such that the angle of reflection could potentially be adjusted by the wearer and/or equipment technician (or potentially accomplished by the system with verbal or other input from the user), as desired.

The size, shape, and placement of the protective visor/combiner relative to the one or more projection lens(es) can vary, as desired. For example, FIGS. 8 through 12 illustrate various sizes, shapes, and locations for a HUD projector and other components relative to an exemplary visor. The illustrated sizes and locations are exemplary and any appropriate size, shape, and location within and/or on the helmet can be utilized.

In various embodiments, the image window on the visor, i.e. the window in which actual information is displayed, can be sized and/or located as desired, including the provision of different amounts and/or locations of information depending upon a specific stage of play. For example, during play an image window can be displayed in a corner and/or along an edge of the visor so that the player is not distracted, but still has the information available, if desired. When the play has ended, or during other activity on the field, the image window can be displayed larger on the visor. The HUD system can be configured such that the image is automatically resized based on helmet movement and/or in response to an external and/or user activated system, which potentially indicates when an active play is in process. Alternately, or in addition, the HUD system can be configured such that the resizing and/or relocation of images is a manual operation by the wearer.

In various embodiments, the image information seen by the wearer can be configurable. For example, the computer system and/or other system components can be configured with different “views” or image screens that the wearer can select. For example, various information can be presented to the wearer using several image screens or “views,” which can include a variety of potential player input techniques to allow the player to “scroll” through individual views. For example, a first view could represent field conditions surrounding the player, including field temperature, wind speed and direction, relative humidity and/or air pressure and play clock time remaining. A second view could provide a list of potential plays to be “called” on the field, which could include a list of cues for audible calls by the team leader to modify a currently called play to accommodate an offensive or defensive repositioning by the opposing team. A third view could be activated by motion of the player (i.e., detected by an accelerometer in the helmet) and/or upon “snapping” of the ball (i.e., detected by an external signal, a visual cue from a helmet camera and/or by an aural signal), which could provide live action views of the surrounding area (i.e., an external view from a rearward facing camera) as well as play and player information (i.e., opposing players could be highlighted in red, with a potential “run route” for one or more players highlighted in green). The views could be customized to meet an individual player's needs, which may be customizable based on the player's position and/or the current game situation (i.e., accelerated presentation during a two-minute drill), or on some other basis. In addition, the views could be customized for each player, which could include a player identifying himself or herself by, e.g., logging into the computer system, by using a token such as, e.g., a RFID tag, or by some other means, wherein the computer system could display a set of “views” that are specific to the player, e.g., based on the player's preferences, experience level, etc.

In various embodiments, the player can turn the HUD on and off and/or scroll through the “views” using a variety of controls on the football helmet, which could include touch sensitive locations and/or touch screen controls on the inside and/or outside of the helmet, the inside and/or outside of the helmet visor, the facemask and/or the chin strap. Alternatively, or in addition, the player might control the HUD using voice or movement commands, wherein the system could include a microphone system, camera and/or accelerometer that picks up audio or physical commands from the wearer. The microphone system or other sensors can then relay the audio commands to the computer system, which can interpret the commands and send the appropriate instructions and information to the computing system. The computing system or other information generating device will then control projector and/or combiner based on the received information and instructions. For example, a player could say “SHOW CURRENT CONDITIONS” and the system will display the surrounding environmental conditions (as previous identified). Other voice commands can be used to allow the user to display the desired information. These voice commands can be used, prior to, during or after the completion of an active play. In addition to the commands discussed above, the player might be able to adjust the size and location of the image window, the brightness of the image display, the color of the image display, etc. In some embodiments, the player may wish to control the opacity of the image to make the image more or less transparent, e.g., from nearly 100% transparent to 100% opaque, while in other embodiments, one or more of these parameters can be adjusted automatically by the computing system based on the current play activity and/or the level of ambient light.

Where incorporated into a HUD system, a microphone may include any suitable audio recording component. The microphone may be used to receive voice commands from the individual to control the HUD, to receive voice notes, to conduct telephone calls or other communications, or to capture other relevant sounds during the course of an athletic activity such as the sound of the athlete's helmet contacting another player's helmet, the sound of a coach calling out an instruction to the individual, or the sound of a referee's whistle blowing.

In various embodiments, an individual can be engaged in the sport of football while wearing a protective helmet such as described herein. While embodiments of the present invention are primarily discussed with respect to the sport of football, the athletic activity HUD systems and methods described herein may be suitable for use by individuals or other interested individuals for team or individual athletic activities and for competitive and informal training sessions in other sports as well. For example, the athletic activity HUD systems and methods described herein according to embodiments of the present invention may be suitable for use by individuals engaged in athletic activities such as baseball, basketball, bowling, boxing, cricket, cycling, golf, hockey, lacrosse, soccer, rowing, rugby, running, skateboarding, skiing, snowboarding, surfing, swimming, table tennis, tennis, or volleyball, or during training sessions related thereto. In a similar manner, alternative embodiments of the inventions described herein could be employed for impact-related uses, such as protective equipment for law enforcement and/or soldiers in combat environments.

In various embodiments, the output of an exemplary HUD may include both a visual display output along with non-visual information such as audio (e.g. via a speaker) and/or tactile (e.g. vibration) output, in addition to or instead of visual display output.

In various embodiments, a video camera or other suitable video recording component, such as a digital video camera, can be incorporated into the HUD system. In some embodiments, the video camera may be configured and oriented such that the video camera may view the environment in front of the helmet (i.e., through an opening in the front of the helmet) to perceive and record a “first person” view of what the individual wearing the HUD system “sees” while engaged in their athletic activity. Any video recorded may be played back to the individual or other interested individual in real time or after the recorded event. In some embodiments, the HUD system may playback a recorded video that is annotated with other visual images, such as the images discussed throughout as being potentially displayed in the projected image field. In one embodiment, first person recorded video may be played back to the individual wearing the HUD system such that the first person recorded video takes up the individual's entire field of view. In this sense, the first person recorded video may provide a “virtual reality” experience to the individual. In another embodiment, the first person recorded video may be played back to the individual wearing the HUD system such that the first person recorded video takes up less than the individual's entire field of view. For example, the first person recorded video may be displayed in one corner of the individual's field of view (i.e., a picture-in-picture view) so that the individual may view the video or shift their attention to other real-world items in their field of view.

Incorporating a video camera into an embodiment of a helmet HUD may provide the HUD with additional capabilities. For example, the HUDs according to various embodiments of the present invention incorporating a video camera may be used to determine the orientation of the individual's body to the ball or other playing object, determine the orientation of the playing object to the goal (i.e. determine when a touchdown or other goal is scored based on a recorded video image of the ball entering the end zone or goal), determine the flight speed, rotation rate and/or rotation speed of the ball, determine the number of ball touches or out-of-bounds location, or even trigger the taking of a still photo or video clip by the HUD system based on a determination of a ball impact.

In various embodiments, a HUD system can be provided to non-players, such as to a coach, a referee or umpire, a team physician and/or a sports fans. A coach's HUD may allow the coach to communicate with one or more individuals during an activity, such as players also equipped with HUDs. Communication may include audio (e.g. voice) communication and/or visual (e.g. text messages, images, or videos) communication. In one embodiment, the coach's HUD may present the coach with a visual illustration of a desired play, formation, player route, or other visual information about desired player movement during the activity. And in some embodiments, the system could be adapted such that one or more players (e.g. all players, a team captain, or a player currently in possession of the ball) can simultaneously view the same visual information about desired player movement on their own HUD system that the coach is viewing in his HUD system. In this way, a coach and his players can share information and strategize in real time during an athletic activity about desired player movements without having to huddle together during a stoppage of play (e.g. a timeout).

In various embodiments, a helmet mounted HUD system can also be a useful tool for a variety of “augmented reality” applications, including for use by players during a football practice event. In its simplest terms, augmented reality presents computer-generated sensory input to a user, including superimposed graphics, audio, haptic feedback, or other sensory enhancements, that provide information about the environment and its objects in the context of a real-world environment. For example, American football fans are accustomed to the presence of a super-imposed “first-down” line on televised American football games, which could similarly be provided to a player through a helmet HUD system on the actual field of play. Moreover, the use of unique symbols and/or color coding schemes that can be virtually superimposed on actual objects (as seen through the helmet HUD) has the potential to provide significantly more immediately useful information to the player about the playing field and conditions, teammates and/or opposing players. For example, various colors such as red, yellow, blue and/or green (or even multiple colors or flashing indicators) can be superimposed on real objects and/or other players via the combiner to indicate potential conditions, such as identifying the ball carrier, eligible receivers, out-of-bounds lines and/or first down markers.

All references, including publications, patent applications, and patents, cited herein are hereby incorporated by reference to the same extent as if each reference were individually and specifically indicated to be incorporated by reference and were set forth in its entirety herein.

The various headings and titles used herein are for the convenience of the reader, and should not be construed to limit or constrain any of the features or disclosures thereunder to a specific embodiment or embodiments. It should be understood that various exemplary embodiments could incorporate numerous combinations of the various advantages and/or features described, all manner of combinations of which are contemplated and expressly incorporated hereunder.

The use of the terms “a” and “an” and “the” and similar referents in the context of describing the invention are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., i.e., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventor for carrying out the invention. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A helmet system, comprising:
a protective enclosure, the protective enclosure having at least two bases, the at least two bases are spaced apart to form a space.
a helmet, the helmet having at least one outer layer and an impact mitigation layer, at least a portion of the impact mitigation layer having a pocket disposed within, the pocket sized and configured to receive the protective enclosure; the protective enclosure being removably coupled within the pocket.

2. The helmet system of claim 1, wherein the space is sized and configured to receive at least one electronic communications module (ECM).

3. The helmet system of claim 1, wherein at least one of the at least two bases having a recess disposed within.

4. The helmet system of claim 1, wherein the protective enclosure further comprises at least one lid.

5. The helmet system of claim 4, wherein the at least one lid being pivotally coupled to at least one of the two bases.

6. The helmet system of claim 4, wherein the protective enclosure further comprises a flexible hinge, the flexible hinge being coupled a portion of the at least two bases.

7. The helmet system of claim 1, wherein the protective enclosure comprises ethylene-vinyl acetate (EVA) foam.

8. The helmet system of claim 4, wherein the at least one lid comprises ethylene-vinyl acetate (EVA) foam.

9. The helmet system of claim 1, wherein the protective enclosure further comprises at least a portion of an impact mitigation structure.

10. The helmet system of claim 8, wherein at least a portion of the impact mitigation structure comprises at least a portion of filaments, laterally supported filaments, auxetic structures, impact foam or foam layer, TPU cones, inflatable bladders, shock bonnets, and/or any combination thereof.

11. The helmet system of claim 1, wherein the space is sized and configured to receive at least one an impact mitigation pad.

12. A protective enclosure, comprising:
a base, the base having a first surface and a second surface, the first surface having a recess disposed within;
a lid, the lid being pivotally coupled to the base, the pivotal connection being a flexible hinge; the recess extending from the first surface towards the second surface; and
an impact mitigation structure, the impact mitigation structure being coupled to the base and lid.

13. The protective enclosure of claim 12, wherein the impact mitigation structure comprises at least a portion of filaments, laterally supported filaments, auxetic structures, impact foam or foam layer, TPU cones, inflatable bladders, shock bonnets, and/or any combination thereof.

14. The protective enclosure of claim 12, wherein the recess is sized and configured to receive at least one stock or custom impact mitigation pad.

15. The protective enclosure of claim 12, wherein the recess is sized and configured to receive at least one electronic communications module (ECM).

16. The method of retrofitting a helmet into a ECM helmet, comprises the steps of:
selecting a desired helmet, the helmet having at least one outer layer and at least one impact mitigation layer;
identifying a preferred regional location within the CA where a protective enclosure may be positioned;
removing at least a portion of the at least one impact mitigation layer to create a pocket or chamber sized and configured to receive a protective enclosure;
securing the protective enclosure within the pocket or chamber.

17. The method of claim 16, wherein identifying a preferred regional location further comprises using “position-specific” factors to determine preferred regional location.

18. The method of claim 16, wherein the protective enclosure comprises at first base and a second base, the first base and the second base forming a space therebetween.

19. The method of claim 18, wherein the first or the second base having first surface and second surface, the first surface having a recess disposed within.

20. The method of claim 19, wherein the recess being sized and configured to receive at least one electronic communications module (ECM) or at least one impact mitigation pad.
